(19) United States
(12) Patent Application Publication
(10) Pub. No.: US 2008/0208654 A1
(43) Pub. Date: Aug. 28, 2008

(54) Method And Apparatus For Site And Building Selection

(76) Inventors: Kurt Ira Nahikian, Ada, MI (US); Peter James Skomia, Rockford, MI (US); John Charles Cottrell, Grand Rapids, MI (US); Heather Lynn Buck, Rockford, MI (US); Julie Lee Rider, Kentwood, MI (US); Kristi Sue Vander Stelt, Grand Rapids, MI (US); Brandon Boyd Goshman, Grand Rapids, MI (US)

Correspondence Address: QUARLES & BRADY LLP, 411 E. WISCONSIN AVENUE, SUITE 2040, MILWAUKEE, WI, 53202-4497, US

(21) Appl. No.: 11/968,880

(22) Filed: Jan. 3, 2008

Related U.S. Application Data
(60) Provisional application No. 60/878,812, filed on Jan. 5, 2007.

(51) Int. Cl. G06Q 10/00

(52) U.S. Cl. 705/7

(57) ABSTRACT

A site/building decision facilitating apparatus including a database that correlates building characteristics with business driver factors, a processor linked to the database and running a program to perform the following acts: receiving business driver factor information for a first building project via an input device and identifying a subset of default building characteristics for the first building project using the database and the received business driver factor information

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to site and building selection methods and apparatus and more specifically to software that accounts for various disparate selection criteria or factors such as business drivers, intended business uses, the industry associated with a building project, construction costs, personnel costs when determining the overall costs associated with constructing and operating a facility at a particular location.

Whenever an employee of a business is charged with real estate decisions (hereinafter a “real estate decision maker”) decide to design/locate a new building, the decision maker should account for many different factors or business drivers (e.g., factors that affect new building location and design) to optimally complete the design and locating process. Exemplary business drivers that may be associated with a new building include but are not limited to drivers related to employee productivity, customer experiences, availability and cost of different types of labor, environmental impact, first time cost to build, real estate related energy costs, the affect on recruiting, training and retaining employees, etc.

Public databases have been developed that can be used by real estate decision makers to develop a general understanding of how different building locations may impact certain business drivers. To this end, public databases currently exist that store statistical information related to various labor related business drivers such as average employee salaries, skill sets of potential employees within geographic regions, employee retention rates, unemployment rates, etc. Similarly, databases exist that store statistical data regarding construction material costs and construction labor costs based on geographic regions.

While public statistical labor and construction databases exist, currently there is no known way to easily access existing data regarding building construction costs and labor related factors in a format that would be meaningful/useful to a real estate decision maker. For this reason, in many building design and locating endeavors, location related cost and rate data may be only anecdotally considered because of its format and an inability to translate the existing data into building specific information. Thus, while data may exist that indicates that a software engineer can be hired for 30% less in Detroit, Michigan than in San Diego, Calif. while widget assemblers can be hired for 10% less in San Diego than in Detroit Mich., translating that information into labor cost savings associated with a specific building in each of the two locations where it is anticipated that 20% of the employees will be software engineers and 80% will be widget assemblers it not an easy task and therefore, in many cases, is simply not done. Instead, because 80% of employees are to be widget assemblers a decision maker may simply look to San Diego as the location where widget assembler wages are low and opt for that location over Detroit.

When real estate decision makers require more geographically specific information to make building decisions, many real estate decision makers rely on design, construction and human resource consultants to provide advice. These consultants develop valuable expertise in their respective fields and can typically customize statistical information for decision makers so that decisions are made in a more informed environment.

While building design and location selection processes have been developed by consultants, unfortunately, there are several shortcomings in the current building locating and designing processes that result in less than optimal decisions.

First, while design, construction and human resource consultants each have developed various skills that are useful when selecting the location for a new building or for designing a building to meet a client's needs, typically these consultants work separately and in a vacuum (i.e., generally not knowing what other consultants are doing). For instance, human resource consultants may provide specific labor related statistical information (e.g., unemployment rate, average wages for different types of employees, turnover rates, typical educational background, etc.) for different locations to help a client select a location for a new building but typically have no special knowledge regarding building design or construction costs and do not care much about those statistics. In contrast, design consultants typically design a building that is consistent with business drivers related to building design and have no special knowledge about labor statistics or, in many cases, even costs associated with constructing the building that is being designed. In fact, in many cases design consultants are hired to design a building without even knowing where the building will ultimately be located and therefore the design consultants cannot know how much it will cost to construct the designed building as costs can vary appreciably as a function of location. Similarly, construction consultants typically bid on a building designed by a design consultant without any special labor related knowledge and with little or no input into the building design.

Moreover, even where design, construction and human resource consultants do share information or all share information with a decision maker, there is no known way to quickly and relatively inexpensively integrate data from the various consultants to help real estate decision makers make well informed decisions. Thus, decision makers typically approach the location, design and construction portions of the decision making process in stages, first selecting a small number of possible building locations, then designing a building and thereafter selecting a final location at least in part based on location related construction costs for the designed building.

While the location-design-construction cost progression may seem logical, such a sequential regimen can have unintended consequences. For instance, in some cases a decision maker may use labor related costs in an initial process to identify two possible building locations. After the two locations are identified and a building design has been selected, the decision maker may use construction costs to select one of the two locations as a final location for the building. In this case it may be that third, fourth and fifth locations have better overall mixes of construction and labor costs which could have reduced the long term costs associated with the building appreciably and therefore the sequential process results in a less than optimal decision.

Second, in many cases real estate decision makers and their consultants never clearly define which of the business drivers are driving the design and location processes and/or the relative importance of the drivers. To this end, typically different business drivers are important to each of the different consultants used by real estate decision makers. For instance, human resource consultants are primarily interested in labor related business drivers like recruiting, retention and training of employees, wage rates, skill sets within specific geographical regions, etc., and are generally not concerned with design related factors such as how a building affects customer experiences, how a building fosters employee communications, employee cooperation, employee innovation, employee productivity or flexibility of a workplace. In contrast, a design engineer typically has no interest in labor related business drivers and instead is completely focused on design related drivers like how a building affects customer experiences, how a building fosters employee communications, employee cooperation, employee innovation, employee productivity and flexibility of a workplace. Similarly, construction consultants are typically interested only in cost related business drivers and have very little interest in the labor related and design related business drivers.

Each consultant, having his or her own area of focus, naturally stresses the importance of the business drivers that are important in the consultant's field of expertise. The real estate decision maker often gets lost in the middle of the consultants and usually cannot even articulate a possible list of business drivers much less rank drivers in the order of importance for a specific building endeavor. In many cases the consultant that makes the greatest impression on the decision maker can end up driving the entire process such that drivers that are not related to the consultant's field but that should have been important to the decision maker are relegated to a secondary status at best.

Third, because some of the business drivers are relatively easy to generate metrics for while others are difficult to quantify, many decision makers and consultants are inclined to simplify the decision making process by focusing only on easily quantifiable business drivers. For instance, it is generally accepted that a well designed and aesthetically appealing building can enhance employee recruitment, training efforts, collaborative activities and productivity and can increase employee retention rates. Nevertheless, because the degree to which building design affects employee factors is not easily quantifiable, often design takes a back seat to easily quantified construction costs. For example, where construction costs can be reduced by 10% by eliminating half of the planned windows in a building and there is no hard metric indicating how such a change would affect employee related factors, it is difficult to argue against the window cost reduction. In short, while cost and employee related factors may both be important business drivers for a building, in many cases building decisions are reduced to abbreviated decision processes wherein cost is a primary consideration while employee related factors are either not considered or are only secondarily considered.

Abbreviated decision processes have short term appeal as they provide comfort to decision makers and consultants that, at least regarding the easily quantifiable metrics, the right decisions are being made. Unfortunately, in the long term, in many cases, abbreviated processes do not yield optimal results and can increase costs appreciably. For instance, it is generally known that building costs are a fraction of employee costs (e.g., wages, recruiting, training, insurance, retention, etc.). It is also generally accepted that when employees find the spaces in which they work appealing, employee costs can be reduced appreciably as the space aides recruiting and retention efforts, may increase productivity, may increase collaboration, etc. In this example it will be assumed that construction costs are only 10% of anticipated yearly employee costs. Here, if an initial construction cost increase of 10% for better furniture or building design results in a 1% employee retention rate increase, the 10% increase in construction costs can be offset in one year by the reduced employee turnover rate alone. In addition, recruiting and training costs may be reduced and collaborative activity may be enhanced by the increase in furniture costs and/or better building design so that the increase in construction costs is offset even faster. In this example, if construction costs are viewed in a vacuum without considering effects on employees, the end result is appreciably more costly in the long term.

Fourth, even when a real estate decision maker is sawy enough to clearly understand which business drivers are driving the decisions to design and locate a building, because of the nature of the decision making process, the process itself often takes on a life of its own and begins to constrain the decision maker and consultants to other than optimal designs and locations. For instance, once the location selection and design processes have progressed and the decision maker and consultants have all spent substantial time and effort in moving a building project toward an end goal, obviously the costs associated with a decision maker's time and effort in considering specific designs and locations cannot be recouped. In addition, most consulting costs cannot be recouped when a real estate decision maker decides not to pursue an initial design direction or location (i.e., when a design change or building location change is made).

For these reasons, at some point during the design and locating process, decision makers and consultants often feel compelled/constrained to continue along the path already started even after the decision maker and/or consultant suspects that the path is no longer optimal. As a simple example, consider a case where a decision maker initially contemplates constructing a building to house a customer call center in San Diego and only later, after extensive efforts related to a San Diego site, recognizes that there may be some advantages to placing the call center in Kansas City. While there may in fact be many advantages to the Kansas City location, the decision maker and/or consultant may be compelled to stick with the San Diego site in order to justify costs already incurred. Once again, here, the process leads to a less than optimal building location decision.

### BRIEF SUMMARY OF THE INVENTION

It has been recognized that many different rules of thumb can be developed and stored in a database that relate default/common facility characteristics to user specifiable factors. Here, after at least a small subset of factors related to an anticipated building have been specified by a user, a processor can use the rules of thumb to generate and render accessible a subset of facility characteristics related to an anticipated facility. In at least some embodiments the default building characteristics can be altered by the user to customize the facility subset and when at least some of the default characteristics are altered, the alterations ripple through the other characteristics in the facility characteristic subset.

Exemplary factors related to an anticipated facility that may be provided by the user include but are not limited to any subset of business drivers, the number and types of employees that are expected to use the building, the location of the building, physical characteristics of the building, the industry in which the building is to be used, the location of the building and characteristics regarding labor expectations (e.g., turnover rate, wage rate, etc.). Exemplary business drivers include productivity related factors, customer/client related factors, real estate energy costs, availability and cost of labor, capital investment factors, environmental impact factors, factors related to communication with employees, factors related to customer service, factors related to construction costs, factors related to innovation fostering, factors related to recruiting, training and retention of employees, factors related to speed of construction, factors related to workplace flexibility and factors related to workplace culture. In at least some embodiments relative importance of the business drivers may be specifiable and the building characteristic subset may be selected as a function of the relative importance as specified.

In at least some embodiments, after a small number of facility characteristics have been specified and during a characteristics customization process, a user can jump to a summary page independent of how much customization has occurred to get a quick summary of estimate of facility construction and furnishing costs, estimated labor costs, location related costs and workspace characteristics.

In some embodiments it is contemplated that the system will be capable of identifying likely useful modifications to a facility specified by a system user and will render helpful suggestions to the user. For instance, where a user indicates that first time cost to build a facility is the only important factor to be considered but then specifies a relatively expensive building the system may identify a subset or all of the building characteristics that could be altered to reduce costs and may present that information in any of several different forms to the user.

In some embodiments it is contemplated that the system will be able to identify cost differences other than construction cost differences associated with different building types. For instance, where a first building will reduce energy costs by $0.50 per square foot when compared to a second building, the system may be able to estimate the $0.50 cost savings. As another instance, where a first building will reduce churn (i.e., reconfiguration costs) costs by $0.60 per square foot per year, the system may be able to estimate the $0.60 cost savings. Where other than construction costs can be determined by the system, the system may also generate and present other useful metrics including but not limited to a net effective rent (NER) value which is the triple net lease cost of a facility minus other costs (e.g., the $0.50 and $0.60 energy and churn savings above) that would be incurred if a different type of facility were constructed.

In some embodiments the system may also be able to identify estimated profit increases as a function of different building characteristics and report those increases either as raw data or reflect those increases in an NER value.

To the accomplishment of the foregoing and related ends, the invention comprises the features hereinafter described. The following description and the annexed drawings set forth in detail certain illustrative aspects of the invention. However, these aspects are indicative of but a few of the various ways in which the principles of the invention can be employed. Other aspects, advantages and novel features of the invention will become apparent from the following detailed description of the invention when considered in conjunction with the drawings.

### BRIEF DESCRIPTION OF THE SEVERAL VIEWS OF THE DRAWINGS

FIG. 1 is a schematic view illustrating a computer and communication system according to at least some embodiments of the present invention;

FIG. 2 is an exemplary building type/default employee database that may be included as a portion of the proprietary database shown in FIG. 1;

FIG. 3 is a primary operations center database that may be included as a primary operations center database of FIG. 1;

FIG. 4 is a flow chart illustrating at least one method that may be performed by the server of FIG. 1 that is consistent with at least some aspects of the present invention;

FIG. 5 is a flow chart illustrating a subprocess that may be substituted for a portion of the process shown in FIG. 4;

FIG. 6 is a screenshot that may be provided by the server of FIG. 1 via the display shown in FIG. 1 to enable the system user to rank or bucket various business drivers as mission critical, core drivers, drivers to be considered or not important;

FIG. 7 is a similar to FIG. 6, albeit showing a summary of how different business drivers have been bucketed or ranked by a user;

FIG. 8 is screenshot showing tools that allow a system user to select one of several different types of facilities to be constructed and to provide additional information related to the number of seats to be provided within a facility and the number of employees that it is anticipated will use a facility;

FIG. 9 is a screenshot including tools that allow a system user to input targets and assumptions for a facility to be constructed;

FIG. 10 is a screenshot including tools that allow a system user to input location related information corresponding to a facility to be constructed and also includes a subwindow that provides some summary information related to employees expected to use a facility;

FIG. 10A is an exemplary subwindow that provides summary information related to a building;

FIG. 10B is similar to FIG. 10A, albeit providing workspace related summary information;

FIG. 11 is a screenshot including tools that enable a system user to view default employee characteristics and wages and to alter those characteristics and wages;

FIG. 12 is a screenshot including tools that enable a system user to view exemplary building shapes and to select one of the building shaped for a facility to be constructed;

FIG. 13 is similar to FIG. 12, albeit allowing a system user to view and select building entry type;

FIG. 14 is similar to FIG. 12, albeit allowing a system user to view and select roof types for a building to be constructed;

FIG. 15 is similar to FIG. 12, albeit allowing a system user to view arid select different mixes of exterior skins for a building to be constructed;

FIG. 16 is a screenshot allowing a system user to view and specify various characteristics related to a building and the location at which the building is to be constructed;

FIG. 17 is a screenshot including tools that allow a system user to view and edit at least a subset of core choices for a building to be constructed;

FIG. 18 is a screenshot including information related to user workspaces within a facility to be constructed;

FIG. 19 is a screenshot including tools to allow a system user to view a basic image of individual workspaces and to specify various characteristics of individual workspaces;

FIG. 20 is a summary screenshot including information related to the location at which a building is to be constructed, the employees that it is anticipated will use the building, building characteristics and characteristics of individual workspaces to be included in a building;

FIG. 21 is similar to FIG. 20, albeit including highlighting boxes indicating building characteristics that are inconsistent with the way in which a system user has bucketed business drivers; and

FIG. 22 is a screenshot showing an NER tool.

### DETAILED DESCRIPTION OF THE INVENTION

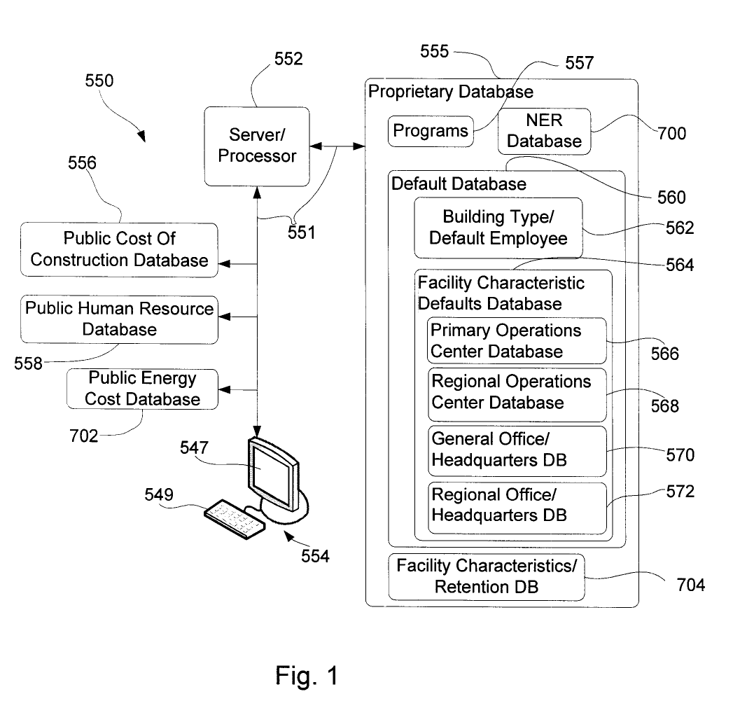

Referring now to the drawings where in similar reference numerals correspond with to similar elements throughout the several views and, more specifically, referring to FIG. 1, the present invention will be described in the context of an exemplary computer and communication system 550 that includes, among other things, at least one server/processor 552, one or more interface devices 554 (only one shown in FIG. 1) and a plurality of databases 556, 558 and 555. Server 552 is linked or linkable via a communication network 551 to each of the databases 556, 558 and 555 and also to interface device 554. At least some of the databases in some of the embodiments will be public databases while other are proprietary.

In FIG. 1, exemplary databases 556 and 558 are public meaning that the data stored therein can be accessed either free of charge or for a small fee by members of the public. Exemplary public databases in FIG. 1 includes a cost construction database 556 and a human resource database 558. Cost construction database 556, as the label implies, includes various statistical information related to the cost of constructing various types of buildings. For example, database 556 may include geographically specific information related to the cost of labor to construct buildings, the cost of specific materials to construct buildings, permit and regulatory costs associated with building specific types of structures, real estate costs including the costs of buying property within geographic areas, etc. In many cases construction cost types of information are maintained by municipalities/governmental agencies which render the information accessible via the internet or the like.

Human resource database 558, as the label implies, may include periodically collected information related to employees within specific geographic areas. For example, employee related data in database 558 may include data related to unemployment rate, educational statistics for people living within specific regions including percent that have college educations, percent that have high school educations, percent that have masters degrees, percent that have doctorates, percent that are trained as managers, percent that are trained as scientists, etc., average hourly rates for employees within particular regions, average hourly rates for employees having specific skill sets within particular regions, retention rates for employees with particular skill sets within particular regions, etc. While databases 556 and 558 are described herein as being public, in at least some embodiments it is contemplated that one or both of databases 556 and 558 may be proprietary or at least supplemented by proprietary databases. Moreover, databases 556 and 558 may comprise a single database or may each comprise two or more public databases.

Referring still to FIG. 1, proprietary database 555 includes one or more software programs 557 and a default database 560. Programs 557 are various programs that are run by server 552 to perform various inventive methods and processes as described below.

Default database 560, as the label implies, includes a plurality of default settings usable by server 552 for specifying various characteristics of buildings/facilities/employees. To this end, default characteristics have been and are continuing to be generated where the characteristics include default or benchmark percentages of employees that work in different types of facilities, typical or common building and workspace features and choices given different building types, different business drivers associated with specific buildings and the number of employees that are expected use a building. The default database 560 includes two sub-databases, a building type/default employee database 562 and a facility characteristics default database 564.

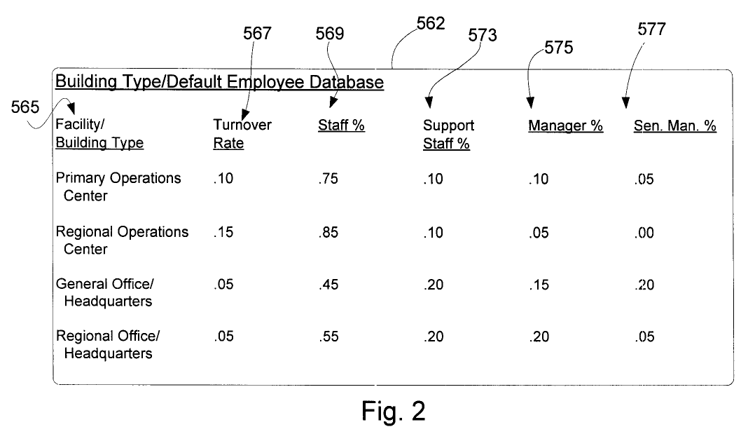

Referring still to FIG. 1 and also to FIG. 2, building type/default employee database 562 relates bench mark employee statistics to four different facility/building types. In the illustrated example, database 562 includes a facility/building type column 565, a staff column 569, a support staff column 573, a manager column 575 and a senior management column 577. Facility/building type column 565, as the label implies, includes a list of different facility types including a primary operation center, a regional operations center, a general office/headquarters and a regional office/headquarters. Here, it is assumed that any new building to be constructed or occupied will be used as either a primary or regional operations center or as a general or regional office/headquarter and therefore the building can be categorized as one or the other of the four types in column 565.

For each of the facility types in column 565, corresponding entries in columns 569, 573, 575 and 577 indicate the percentage of total employees at the facility type that can be categorized as staff, support staff, managers and senior management, respectively. Thus, as shown in FIG. 2, at a primary operations center it may be that statistical information derived from prior project experience has shown that 75% (e.g., 0.75) of the total number of employees will likely be staff employees (e.g., see the entry in column 569 that corresponds to the primary operations center type in column 565). Similarly, at a primary operation center, 10% of the total number of employees will typically or commonly be support staff, 10% will be managers and 5% will be senior managers as indicated in column 573, 575 and 577, respectively, in the row associated with the primary operations center type in column 565. Thus, for example, if a primary operations center is to have 500 employees, given the bench mark defaults in database 562, 375 of the employees will be staff (i.e., 0.75×500=375), 50 of the employees will be support staff, 50 of the employees will be managers and 25 of the employees will be senior managers. In contrast, given the employee breakdown bench mark data in database 562, if 500 employees were to work at a general office headquarters, 225 of the employees would be staff, 100 of the employees would be support staff, 75 of the employees would be managers and 100 of the employees would be senior managers.

Here, it should be appreciated that, while four different facility types are listed in FIG. 2, in other embodiments, more or less facility types may be listed, depending upon what is reasonable given how buildings are used in an industry. In addition, facility types and benchmark employee breakdowns may be different for different industries. For example, while the statistics and facility types in FIG. 2 may be appropriate in the case of a manufacturing industry, entirely different facility types and benchmark employee breakdowns may be more appropriate in the health care industry, education industry, etc.

Referring still to FIG. 2, in addition to the bench mark employee breakdown data provided in columns 569, 573, 575, and 577, bench mark turnover rates are provided for each of the facility/building types in column 565 which can be used to develop relatively sophisticated statistics related to employee or labor costs. In this regard, column 567 includes a separate entry for each one of the facility/building types in column 565. For instance, for a primary operations center, the bench mark annual turnover rate in column 567 is 10% meaning that, where 500 employees work at a primary operations center, 50 of the those employees will turnover on an annual basis. Similarly, for a regional operations center the data in column 567 indicates that 15% annual turnover should be expected while only 5% annual turnover should be expected for an general or regional office/headquarters.

Referring once again to FIGS. 1 and 2, building characteristics default database 564 includes a separate default database for each one of the facility/building types listed in column 565 of database 562. Thus, database 564 includes a primary operations center database 566, a regional operations center database 568, a general office/headquarters database 570 and a regional office headquarters database 572. Each of the databases 566, 568, 570 and 572 is similar in construction and is used or operates in a similar fashion and therefore, in the interest of simplifying this explanation, only primary operations center database 566 will be described here in any detail. The main differences between the databases 566, 568, 570 and 572 are the characteristics specified by the different databases. For example, comparing a regional operations center database to a general office/headquarters database, because headquarters buildings are often designed to be relatively more aesthetically impressive for recruiting and for customer relations purposes, the headquarters database may include defaults that require the best possible signage, wall coverings, furniture, relatively large executive management offices, etc., whereas the regional operations center database 568 may specify lower quality materials, design, relatively smaller executive management offices, etc.

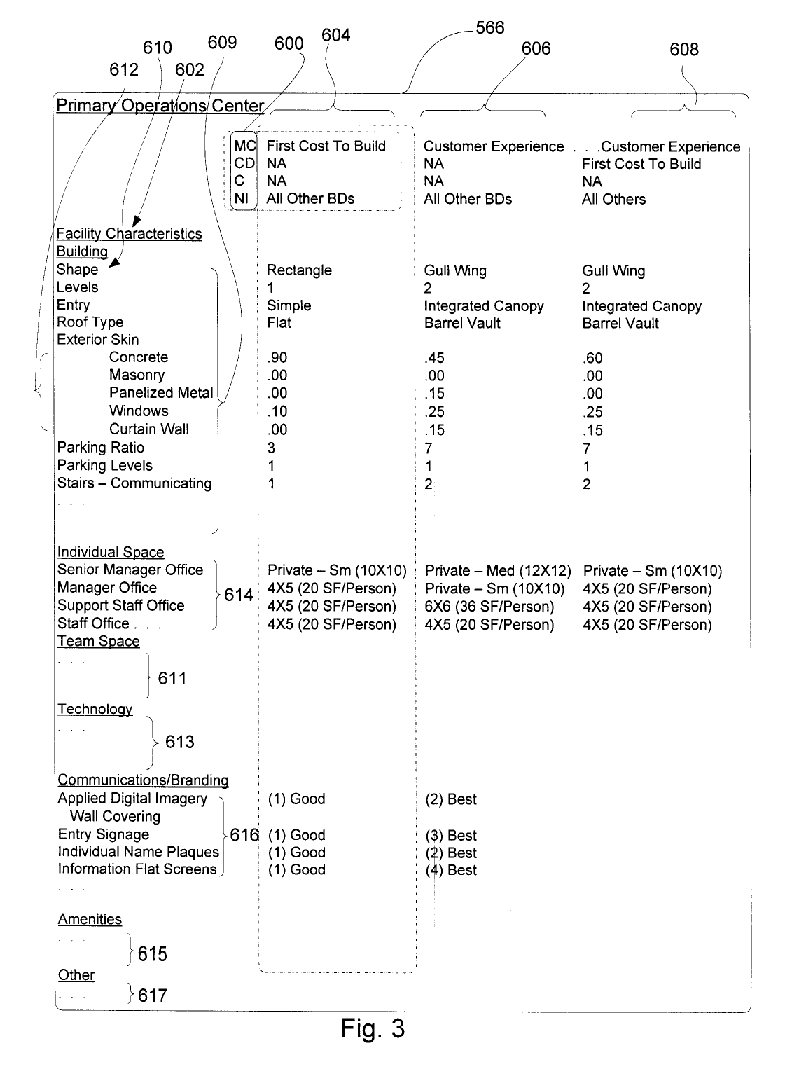

Referring still to FIG. 1 and now to FIG. 3, an exemplary and simplified primary operations center database 566 is shown in FIG. 3. Database 566 includes a facility characteristics column 602 and a plurality of additional column 604, 606, 608, etc., that specify default facility characteristics. As the label implies, column 602 includes a list of facility characteristics which, as shown, are broken down into sub-groups of characteristics including a building sub-group 609, an individual space sub-group 614, a team space sub-group 611, a technology sub-group 613, a communications/branding sub-group 616, an amenities sub-group 615 and an “other” sub-group 617. Under the building sub-group, labels beginning with the first label 610 include shape, level, entry, roof type, exterior skin, parking ratio, parking level, stairs-communicating, etc.

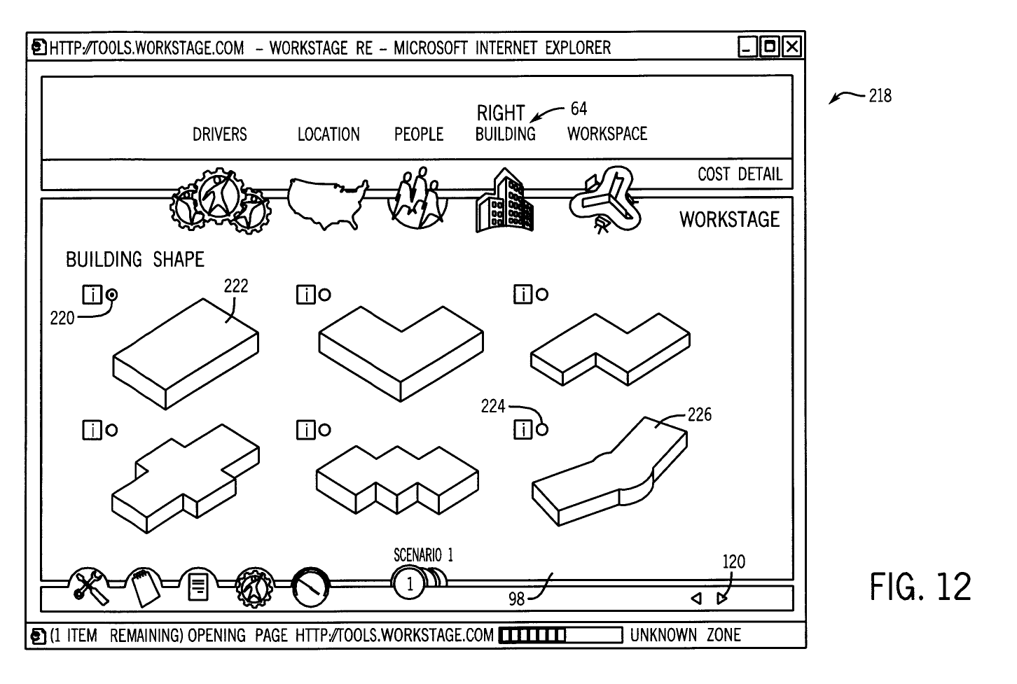

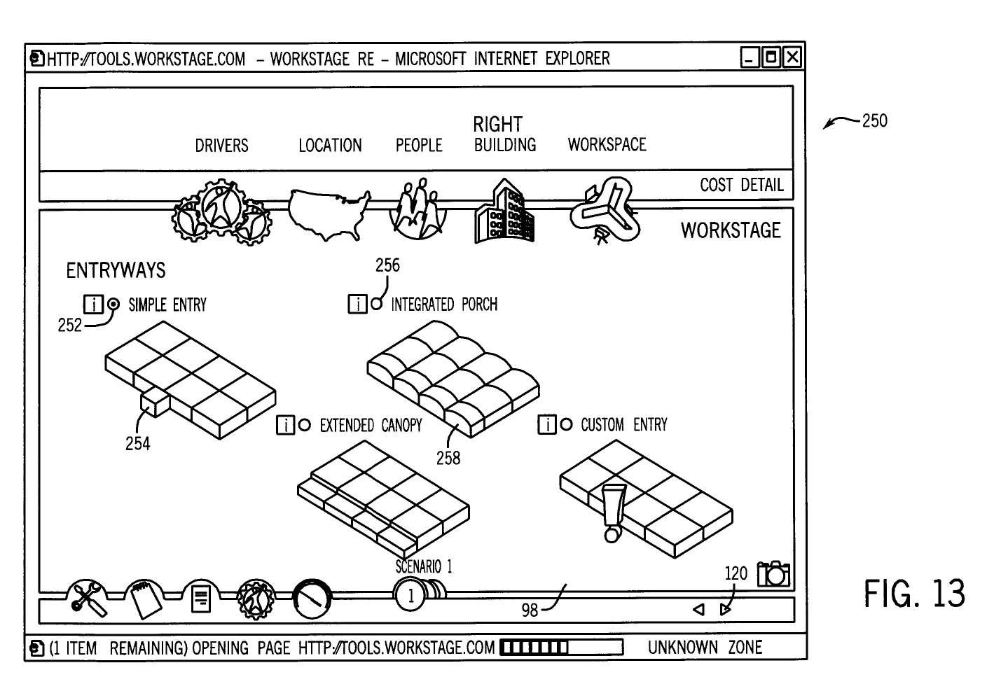

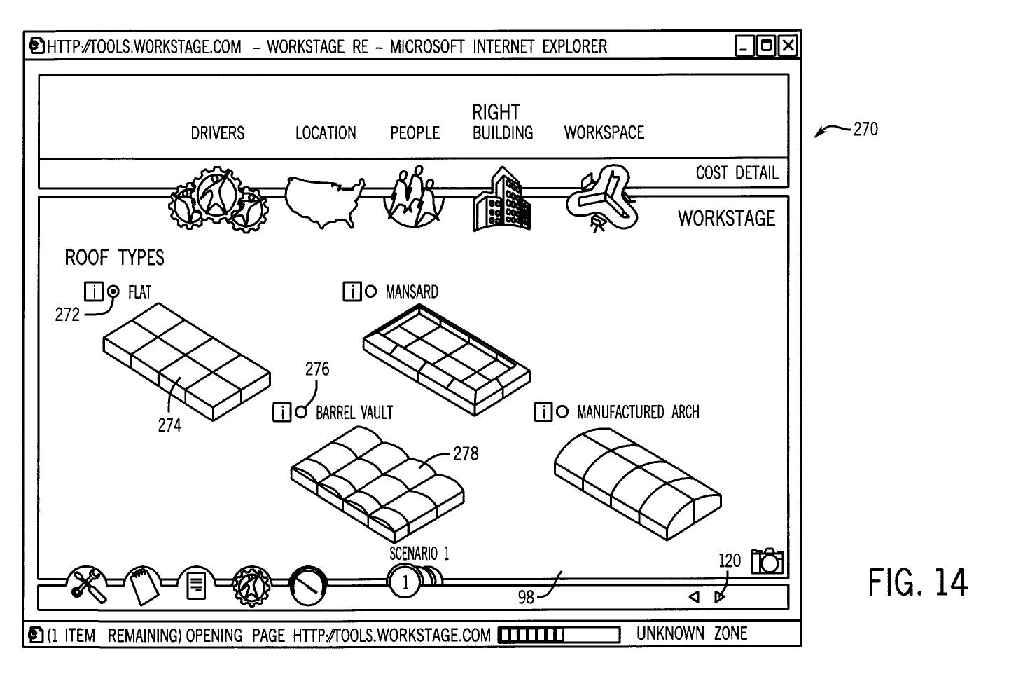

The “shape” label in column 602 corresponds to the general shape of a building to be constructed or occupied. To this end see FIG. 12 where a screen shot 218 shows various general building shapes including a rectangular shape 222, a gull-wing type shape 226 and various other shapes. The “levels” label corresponds to the number of levels (e.g., 1, 2, etc.) of a building to be constructed or occupied. The “entry” label corresponds to the type of entryway into a building to be constructed or occupied. To this end, see FIG. 13 where a screenshot 250 shows various building entry types including, among others, a simple entry 254, an integrated porch entry 258, an extended canopy entry, etc. The “roof type” label corresponds to the type of roof to be included on a building to be constructed or occupied. To this end, see FIG. 14 that shows a screenshot 270 illustrating exemplary roof types including, among others, a flat roof type 274, a barrel vault roof type 278, etc.

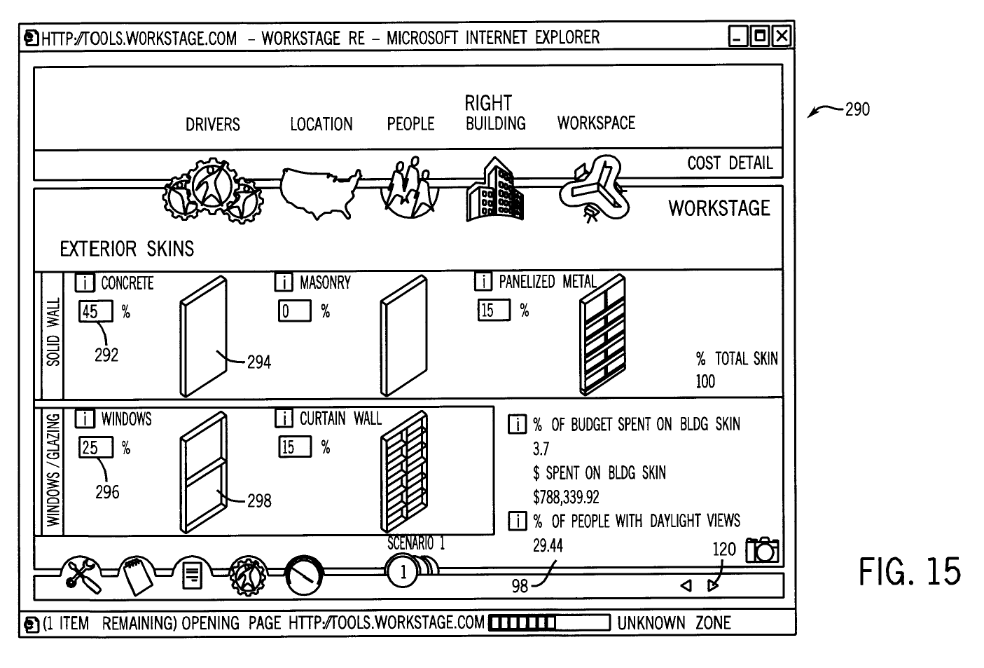

Referring still to FIG. 3, the “exterior skin” label in column 602 corresponds to the material used on the exterior of a building to be constructed or occupied. In this regard, see FIG. 15 where a screenshot 290 shows images of different types of materials to be used on the exterior surface of a building including concrete, masonry, panelized metal, windows and curtain wall. Under the exterior skin label in column 602 a separate label for each of the types of exterior skin is provided, the separate labels collectively identified by numeral 612 in FIG. 3. The “parking lot ratio” label indicates a parking space ratio to be used to determine the number of parking spaces to be included around a building to be constructed. The “parking level” label indicates the number of parking levels to be included if a parking structure is to be constructed. For example, where a parking structure is to have three levels, a parking levels value would be 3. The “stairs/communicating” label indicates the number of stairwells to be included in common or customer related areas to be constructed.

Referring yet again to FIG. 3, under the individual space portion 614 of column 602, different labels are provided for different types of offices including senior manager, manager, support staff and staff. Although not illustrated, the individual space portion of column 602 may also include labels related to individual space or office amenities such as desk, a chair, side chairs, lighting, wall coverings, computer type, monitor type, file cabinets, bins, shelving, side tables, a credenza, etc.

Under the communications/branding portion 616 of column 602, labels are included that are related to “applied digital imagery wall covering”, “entry signage”, “individual name plaques”, and “information flat screens”. While no labels are shown under the team space, technology, amenities, and “other” portions of column 602, it should be appreciated that various labels corresponding to various features will be provided under each one of those portions. Moreover, many other labels are contemplated that will be provided under the facility characteristics, the individual space and the communications/branding portions of column 602.

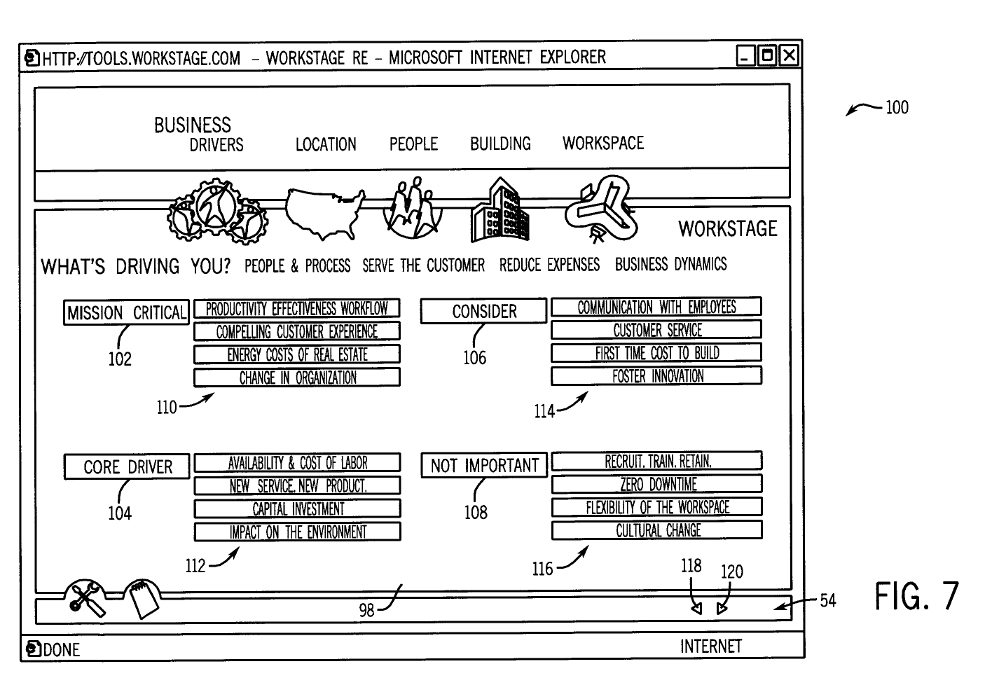

In at least some embodiments, it is contemplated that a list of business drivers may be provided for a system user that can be ranked in terms of their importance in relation to a facility to be constructed and furnished or fitted out for use. Here, the term “business driver” is used to refer to things that may be considered important to a real estate decision maker when going through the process of searching for a location for a building, designing the building and furnishing different parts of the building. To this end, referring now to FIG. 7, sixteen exemplary business drivers that may be provided for ranking by a system user are shown including “productivity effectiveness workflow”, “compelling customer experience”, “energy costs of real estate”, “changes in organization”, “availability and cost of labor”, “new service, new product”, capital investment”, “impact on the environment”, “communication with employees”, “customer service”, “first time cost to build”, “foster innovation”, “recruit, train, retain”, “zero down time”, “flexibility of work space” and “cultural change”.

As shown in FIG. 7, in the illustrated example, a system user can bucket the business drivers into any of four different buckets to rank the importance thereof. In this regard, the four buckets of importance in the present example include a “mission critical” bucket 102, a “core driver” bucket 104, a “consider” bucket 106 (also referred to hereinafter as a “to be considered” bucket), and a “not important” bucket 108.

In at least some embodiments it is contemplated that the default facility characteristics that may be provided in the facility characteristics default database 564 (see again FIG. 1) may depend upon the importance of the different business drivers to a system user. For example, where a compelling customer experience is the most important or most mission critical business driver, facility characteristics may be very different than in a case where the first time cost to build a building is the most important or mission critical of the business drivers. For instance, where a compelling customer experience is the only mission critical business driver for a particular building and where first time cost to build is not important, the facility defaults in database 564 may be consistent with a far more expensive building than in a case where the first time cost to build is mission critical and a compelling customer experience is not important.

Referring once again to FIG. 3, each of the columns 604, 606, 608, etc., in the primary operation center database corresponds to a unique group bucketing of the business drivers shown in FIG. 7. In FIG. 3, the abbreviated labels “MC”, “CD”, “C” and “NI” correspond to the mission critical, core driver, consider and not important buckets shown in FIG. 7, respectively. Thus, the information in column 604 corresponding to the labels 600 indicates that the characteristic values in column 604 correspond to the case where business drivers have been bucketed such that the first time cost to build is the only mission critical driver and all of the other business drivers (BDs) are not important (i.e., are in the NI row). Similarly, the information in column 606 corresponding to labels 600 indicates that the only mission critical business driver is a compelling customer experience and that all of the other business drivers are not important. In column 608, the information related to the labels 600 indicates that a compelling customer experience is mission critical, the first time cost to build is a core driver (i.e., is in the CD row) and that all other business drivers are not important.

Referring yet again to FIG. 3 and specifically to column 604, where the first time cost to build is the only mission critical business driver and all other business drivers are not important, it can be seen that, in general, a relatively inexpensive facility is specified by the facility characteristics values. To this end, the shape of the default building in column 604 is a rectangle which is generally the least expensive shape in which to construct a building. Only a single facility level is indicated in column 604. The default entry in column 604 is a simple entry and the roof type is flat, both inexpensive options. Consistent with a relatively inexpensive building, the exterior skin is 90% panelized metal and only 10% windows in column 604. Similarly, consistent with a relatively inexpensive building, the offices specified are relatively small and the communications/branding components and materials are indicated as good which is, in the present example, a relatively low cost indicator (e.g., better and best indicators correspond to relatively more expensive materials and building techniques than the good indicator throughout this description).

Referring yet again to FIG. 3, in contrast to the low cost building defaults in column 604, in column 606 where customer experience is the only mission critical business driver and all other business drivers are not important, a more expensive building is specified by the default values. In this regard, in column 606, the shape of the building is a gull wing type shape as opposed to the simpler rectangular shape in column 604, the building has two levels, the entry of the building includes a relatively expensive integrated canopy, the roof type is a barrel vault, the exterior skin of the building includes much more concrete and many more windows as well as a curtain wall, the offices specified under the individual space portion in column 606 are larger than the offices specified in column 604 and the communication/branding features and materials are indicated as being the best so that a compelling customer experience is more likely.

Referring still to FIG. 3, in column 608 where a compelling customer experience is mission critical, first time cost to build is a core driver and all other business drivers are not important, the default values specify a building that is relatively high quality and is aesthetically pleasing in all areas where customers are expected to function and that is relatively inexpensive in other spaces where customers are not expected to function (e.g., any individual spaces, amenities, etc.).

Referring once more to FIG. 3, it should be appreciated that the database 566 illustrated is extremely simplified and that, in most cases, a much more complex database is anticipated. In this regard, as shown, database 566 includes only three columns 604, 606 and 608 that correspond to three different ways of bucketing or ranking the business drivers. It should be appreciated that there are several thousand different combinations of the 16 business drivers shown in FIG. 7 and that, in at least some embodiments, a database 566 would include a separate column for each one of the different possible ways of bucketing the business drivers. It should also be appreciated that while 16 business drivers are shown in FIG. 7, embodiments with fewer business drivers or a larger number of business drivers or indeed with completely different sets of business drivers are contemplated. Moreover, while four buckets are provided in FIG. 7, and in the example here, in other embodiments, fewer buckets or a larger number of buckets may be used for ranking business driver importance.

In at least some embodiments, instead of providing a separate column in the primary operations center database 566 for each one of the different possible ways of bucketing the business drivers, it is contemplated that one or a subset of the business drivers may be associated with a specific set of facility characteristics such that only the subset of business drivers and how those business drivers are bucketed affect those facility characteristics. For example, in at least some embodiments the compelling customer experience business driver may be the only driver that affects the communications/branding portion of the default facility characteristics. Thus, for instance, regardless of how other business drivers are bucketed, a “best” value may be provided for each of the communications/branding labels in column 602 whenever a compelling customer experience is mission critical, a “better” value may be provided for each of the communications/brandings labels whenever a compelling customer experience is a core driver and a “good” value may be provided for each of the communications/branding labels when a compelling customer experience is either not important or only a consideration. Similarly, other single business drivers or subsets (e.g., two or three, etc.) of business drivers may drive subsets of the facility characteristics independent of how the other business drivers are bucketed so that a simplified primary operations center database can be constructed.

Moreover, in at least some embodiments, some type of equation may be formulated that combines different business driver rankings to generate a single business driver value where the value then dictates which of several sets of facility characteristics to select as default. For instance, in some embodiments there may be one hundred different sets of facility characteristics where the 1^{st} set corresponds to an inexpensive building, the 100^{th} set corresponds to an expensive building and the sets between the 1^{st} and 100^{th} set increase in cost progressively. Despite there being thousands of ways to bucket the sixteen business drivers into the four buckets in FIG. 7, the equation may result in a second level of bucketing where each of the different ways of ranking the drivers corresponds to one of the 100 sets of facility characteristics and therefore corresponds to one of 100 different sets of facility benchmarks.

Referring once again to FIG. 1, interface device 554 may take any of several different forms including a personal computer, a laptop computer, a palm-type computing device, a server, a workstation, a thin client type computing device, etc. In the illustrated embodiment, device 554 includes a keyboard or other input type device 549 such as a mouse and a display screen 557 for receiving output from server 552 and for providing input to server 552.

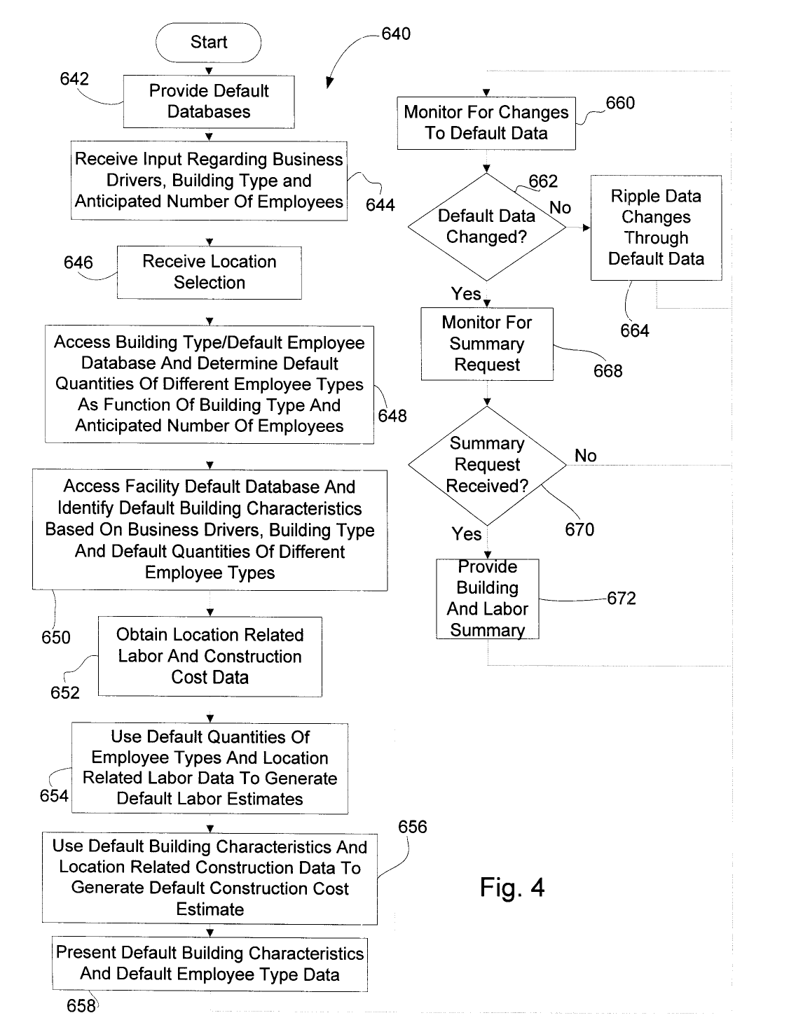

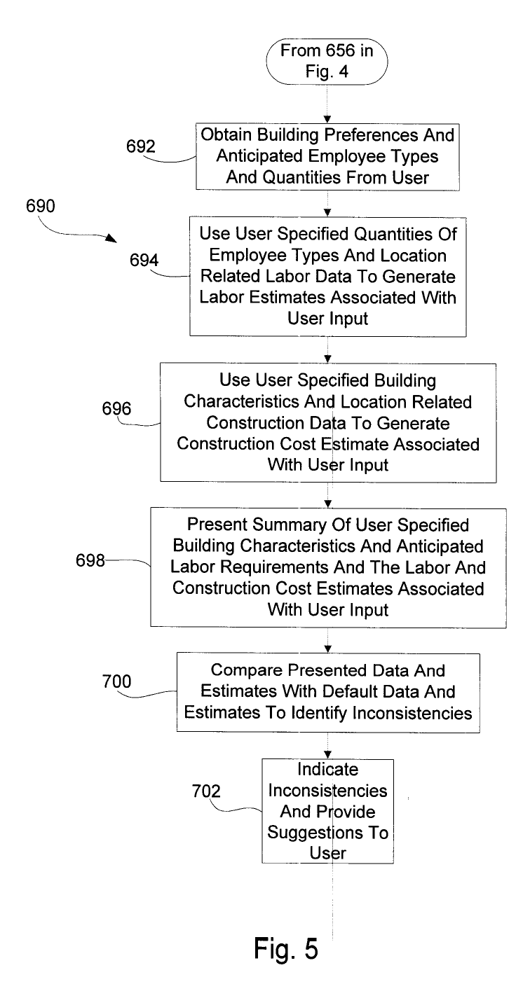

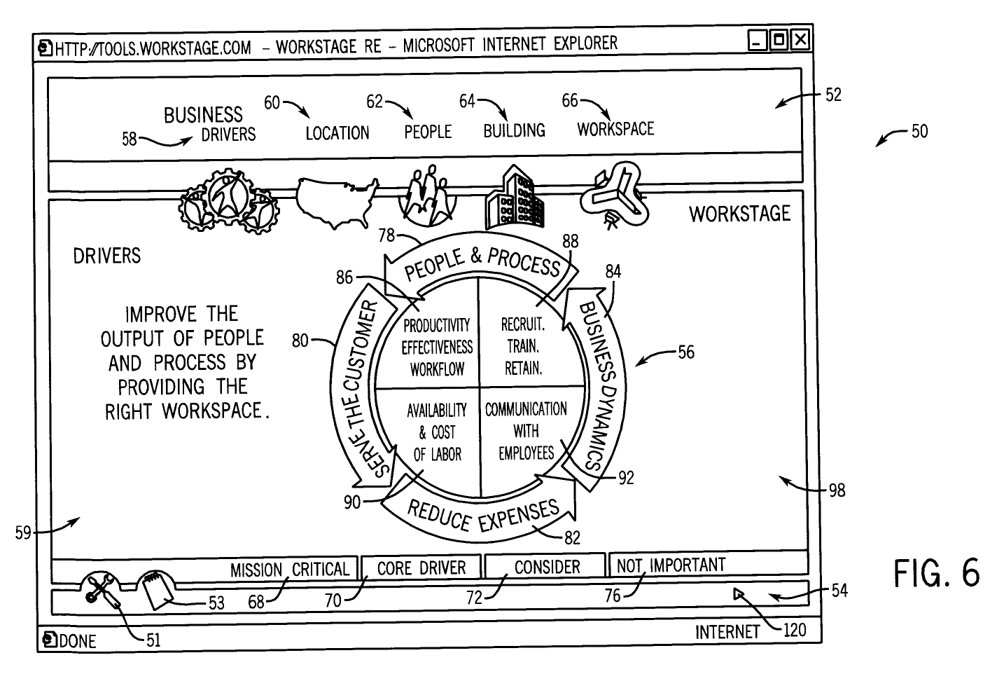

Referring now to FIG. 4, an exemplary method 640 that is consistent with at least some embodiments of the present invention is illustrated. Referring also to FIGS. 1 through 3, at process block 642, default databases 560 are provided which are accessible by server 552. At block 644, a system user provides input regarding business drivers, anticipated facility type and anticipated number of employees to occupy a building to be constructed using interface device 554. To this end, referring also to FIG. 6, a screen shot 50 that may be provided by server 552 via display screen 547 is shown. Screen shot 50 includes a graphical interface display having a primary navigation tool bar 54 along the lower edge thereof and a secondary navigation toolbar 52 along the top edge thereof. Between the primary and secondary tool bars, a data entry space 98 is provided. The exemplary primary navigation tool bar 54 includes a utilities icon 51, a notepad icon 53 and a forward arrow icon 69. Each of icons 51, 53 and 69 is selectable by moving a mouse controlled cursor there over and clicking one of the mouse buttons in a conventional manner. When utilities icon 51 is selected, a pop-up menu (not shown) including mouse selectable labels for various software features appears. When notepad icon 53 is selected, a window opens up in which a user can take notes by typing with keyboard 549 or the like to memorialize thinking during use of the inventive system. Forward arrow icon 69 is selectable to move to a next screen shot shown in FIG. 7 after a user is done using the input tools in space 98 of screen shot 50.

Referring still to FIG. 6, secondary navigation tool bar 52 includes five separate mouse selectable icons including a “drivers” icon 58 a “location” icon 60, a “people” icon 62, a “building” icon 64 and a “workspace” icon 66. Each of the icons 58, 60, 62, 64 and 66 is usable to enter different types of information to be associated with a building to be constructed and/or to navigate back and forth among different screen shots supported by the system. In this regard, it has been recognized that an optimal set of information needed when making a real estate decision can be broken down into several different categories and that the information entry tool can be arranged so that data entry progresses along a logical flow based on those categories. In the illustrated example, the information categories include the categories corresponding to the secondary tool bar 54 icons.

As the label implies, “drivers” icon 58 is selectable to allow a user to enter information related to business drivers associated with a building to be constructed. “Location” icon 60 is selectable to allow a user to access various location related construction and labor statistics and to specify an anticipated location for a new facility. “People” icon 62 is selectable to allow a user to access and alter employee breakdowns for a facility. “Building” icon 64 is selectable to allow a user to examine and specify building characteristics and “workspace” icon 66 is selectable to allow a user to examine and specify characteristics of individual workspaces for a facility.

Referring still to FIG. 6, when “drivers” icon 58 is initially selected, the information shown in space 98 of screen shot 50 is initially provided. Tools are provided in space 98 for considering different business drivers and bucketing those drivers as mission critical, core, to be considered or not important. To this end, a business drivers wheel 56 is provided along with a mission critical bucket 68, a core driver bucket 70, a to be considered bucket 72 and a not important bucket 76.

Referring to FIGS. 6 and 7, while there are 16 different business drivers in the illustrated example, the business drivers in this example have been subdivided into four separate business driver sets labels a “people in process” set, a “service the customer” set, a “reduce expenses” set and a “business dynamics” set, each of the separate sets provided with a mouse selectable arrow icon 78, 80, 82 and 84, respectively, in space 98. In the present example, each of the separate business driver sets includes four of the business drivers shown in FIG. 7. For example, the “people in process” set includes the “productivity effectiveness work flow” driver, the “communication with employees” driver, the “availability and cost of labor” driver and the “recruit, train, retain” driver. As shown in FIG. 6, when the people in process icon 78 is selected, the four drivers associated therewith are provided within a circular space defined by arrow icons 78, 80, 82 and 84. Similarly, although not separately illustrated, the “compelling customer experience” driver, the “customer service” driver, the “new service, new product” driver and a “zero down time” driver in FIG. 7 are all included in the “serve the customer” set associated with icon 80 so that when icon 80 in FIG. 6 is selected, the four related drivers appear within the circle formed by icons 78, 80, 82 and 84. In a similar fashion, when the “reduced expenses” icon 82 or the “business dynamics” icon 84 are selected, the four business drivers related to each of those icons would appear within the circle defined by icons 78, 80, 82 and 84.

Referring still to FIG. 6, after the people in process icon 78 is selected, the four drivers related thereto are provided as mouse selectable icons within the circular space defined by icons 78, 80, 82 and 84. The icons in FIG. 6 include the “productivity effectiveness work flow” icon 86, the “recruit, train, retain” icon 88, and “availability and cost of labor” icon 90 and the “communication with employees” icon 92. When one of icons 86, 88, 90 or 92 is selected, additional information explaining the nature of that icon and that business driver is provided in space 59 to the left of tool 56 and the selected icon is highlighted. Thus, when icon 86 is selected, icon 86 is highlighted and information related thereto is provided in space 59.

To rank or bucket the business drivers corresponding to icons 86, 88, 90 and 92, a user can select the icon associated therewith via a mouse controlled cursor and drag the icon to one of the mission critical, core driver, to be considered or not important buckets 68, 70, 72 or 76, respectively. After all four drivers associated with the people in process icon 78 have been bucketed, the user can select one of the other arrow icons 80, 82 or 84 to access other business drivers and to bucket those drivers in a similar fashion.

After at least one of the business drivers has been bucketed, a user can select forward arrow icon 69 to move to the next screen shot shown in FIG. 7. Referring now to FIG. 7, a next screen shot 100 provides a summary page indicating how business drivers have been bucketed. To this end, separate mission critical, core driver, to be considered and not important icons 102, 104, 106 and 108 are provided in space 98 along with lists of the business drivers that have been bucketed and associated therewith. In the illustrated example, a list 110 of four drivers have been bucketed as mission critical, a list 112 of four drivers have been bucketed as core drivers, a list 114 of four drivers have been bucketed as to be considered and a list 116 of four drivers have been bucketed as not important. At this point, it should be noted that, while four separate drivers have been bucketed in each one of the different buckets, fewer or greater numbers of drivers could have been put in any one of the buckets. In addition, it should be noted that while there are 16 drivers and while all of those drivers have been bucketed in the present example, a user may choose to only bucket a subset of the total number of drivers in which case drivers that are not bucketed are considered to be not important in at least embodiments. At this point, primary navigation tool bar 54 includes both forward and backward arrow icons 120 and 118, respectively, so that a user can, if necessary, back up to screen shot 50 shown in FIG. 6 to modify the way in which business drivers have been bucketed or can move forward to a next screen shot.

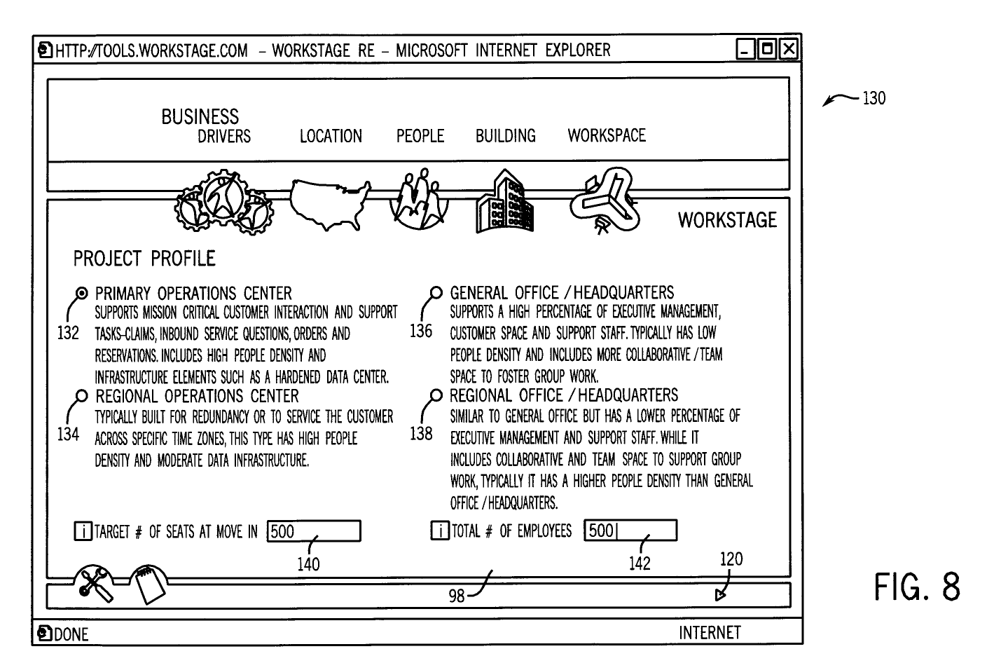

Referring once again to FIG. 1 and now also to FIG. 8, after business drivers have been bucketed and forward icon 120 (see again FIG. 7) has been selected, server 552 in the present example provides a screen shot 130 which allows the system user to indicate a type of building to be constructed and to indicate the total number of employees to use the building and the number of seats or independent work spaces to be included in the building. To this end, screen shot 130 provides four facility or building type options in space 98 including a primary operations center, a regional operations center, a general office/headquarters and a regional office/headquarters. Binary mouse selectable buttons are provided next to each one of the building types including buttons 132,134, 136 and 138. A system user can select one of the binary buttons to place a dot (see button 132) therein to indicate selection of one of the building types for the building to be constructed. Note that the building type options in space 98 correspond to the default databases 566, 568, 570 and 572 in FIG. 1. Seat and employee number fields 140 and 142 are also provided in space 98 where a user can input the number of work spaces that should be included in the new building and the anticipated number of employees to work in the new building, respectively. After the information required in space 98 has been provided, a user can select forward arrow icon 120 to go to the next screen shot.

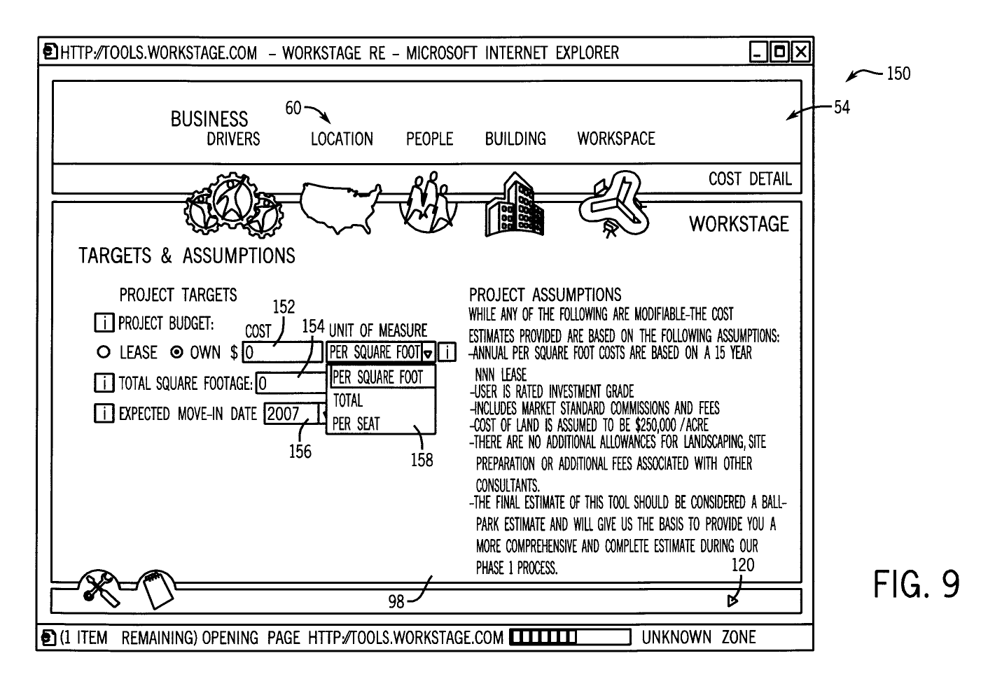

Referring to FIG. 1 and now also to FIG. 9, a next screen shot 150 allows the user to provide target and assumption information regarding project cost, anticipated or desired total square footage and an expected move in date. In this regard, cost, square footage and move in date fields 152,154 and 156 are provided. Pull down menus like menu 158 may be provided to allow a user to qualify information in any one of the fields 152, 154 and 156. Here, inputting information into fields 152, 154 and 156 is optional. To move to the next screen shot, a user selects forward arrow 120 or may select the “Location” icon 60 from bar 54.

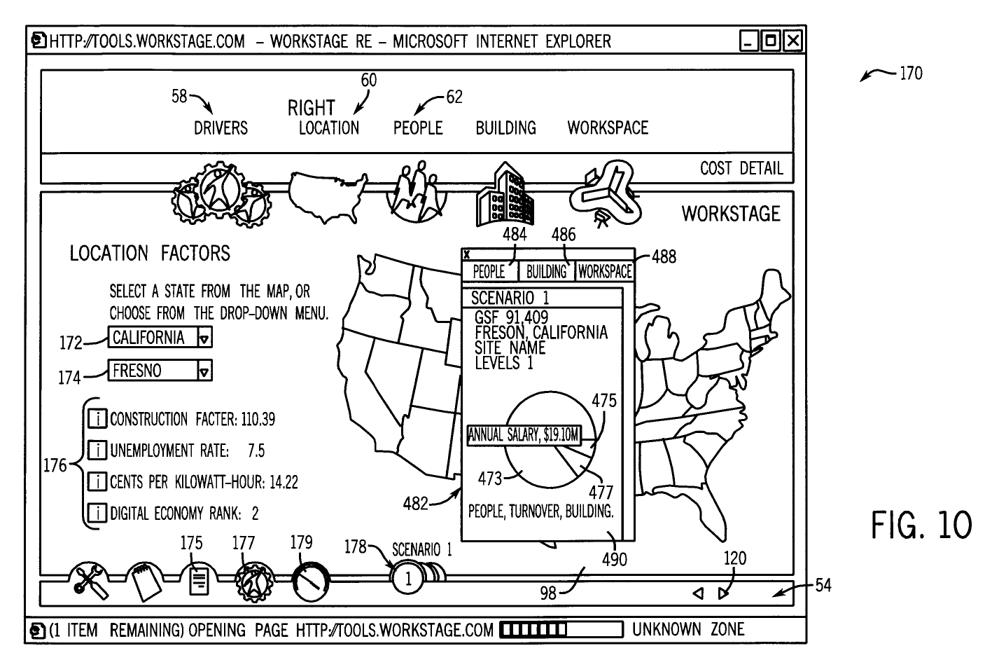

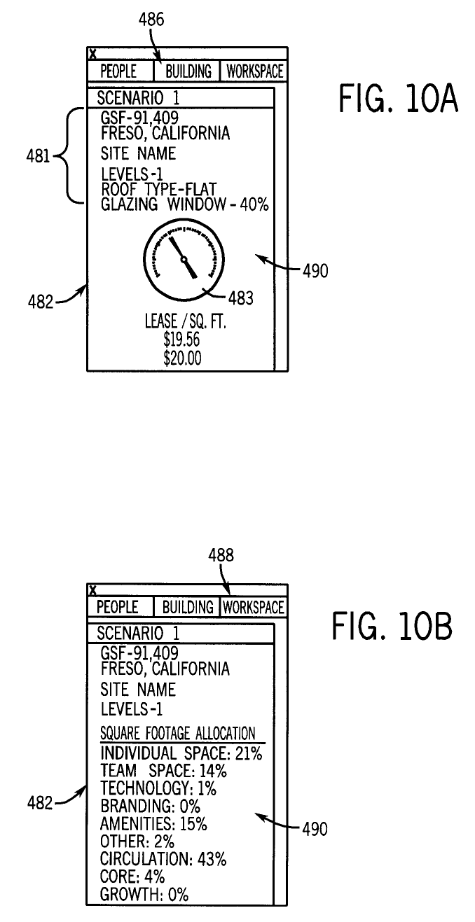

Referring once again to FIG. 4, after block 644, control passes to block 646 where a user uses device 554 to input location selection information indicating the location at which the user would like to construct a facility. Referring also to FIG. 10, a screen shot 170 to help a user select a location for a building is shown. Here, location specifying tools include a state/province field 172 and a city field 174 in which, as the labels imply, state/province and city names can be entered or selected from pull down menus (not illustrated) to specify a specific location for a building. In the illustrated example, the state/province and city selected are California and Fresno, respectively. When a state/province and city are selected, referring also to FIG. 1, server 552 accesses the public cost of construction and human resource databases 556 and 558 to obtain information therefrom related to cost of construction, unemployment, wage rates, energy costs, etc. General or basic cost and related types of information is immediately provided within space 98 as shown collectively by numeral 176 in FIG. 10.

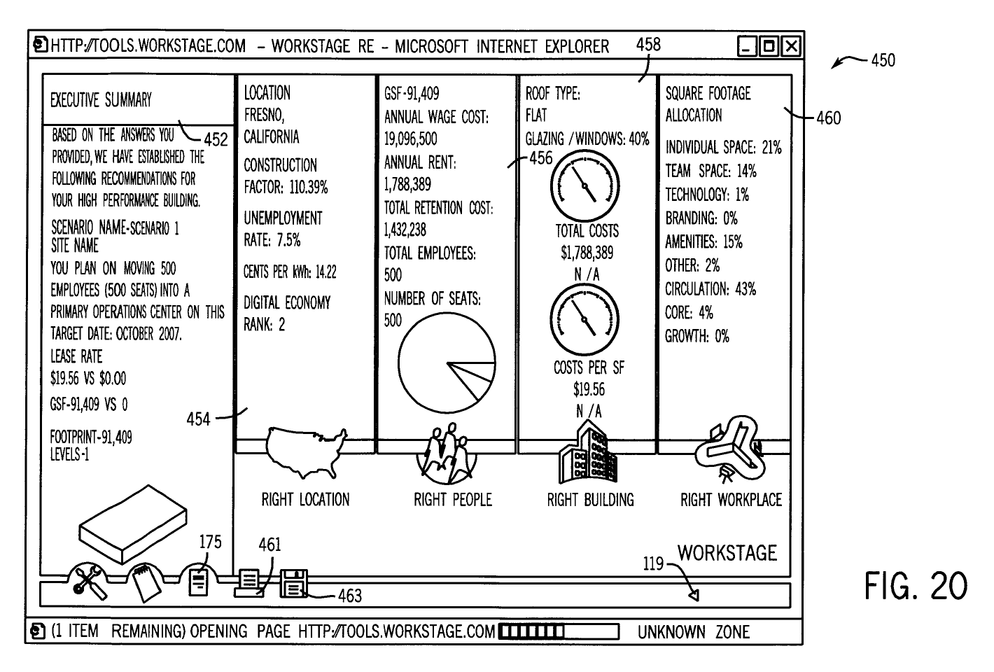

Referring still to FIG. 10, once a location has been specified via fields 172 and 174, a summary icon 175, a drivers icon 177, a dashboard icon 179 and a scenarios icon 178 are provided along with other icons in primary tool bar 54. Summary icon 175, as can be selected at any point after which a location has been selected for a building in order to jump to a summary page (see FIG. 20) for a building project. Here, in general, it has been recognized that, after the limited amount of information described above with respect to FIGS. 6 through 10 has been specified by a system user, facility default characteristics and default employee mixes for specific building types can be used to generate a complete set of building summary information. In fact, in at least some embodiments, after location has been selected at block 646 in FIG. 4, control passes to block 648 where server 552 accesses the building type/default employee database 562 in FIG. 2 and determines default quantifies of different employee types as a function of building type and anticipated number of employees. To this end, in the present example where 500 employees were specified in field 142 in FIG. 8 and the building type is a primary operation center, referring to FIG. 2, the default employee mix would include 375 staff, 50 support staff, 50 managers and 25 senior managers.

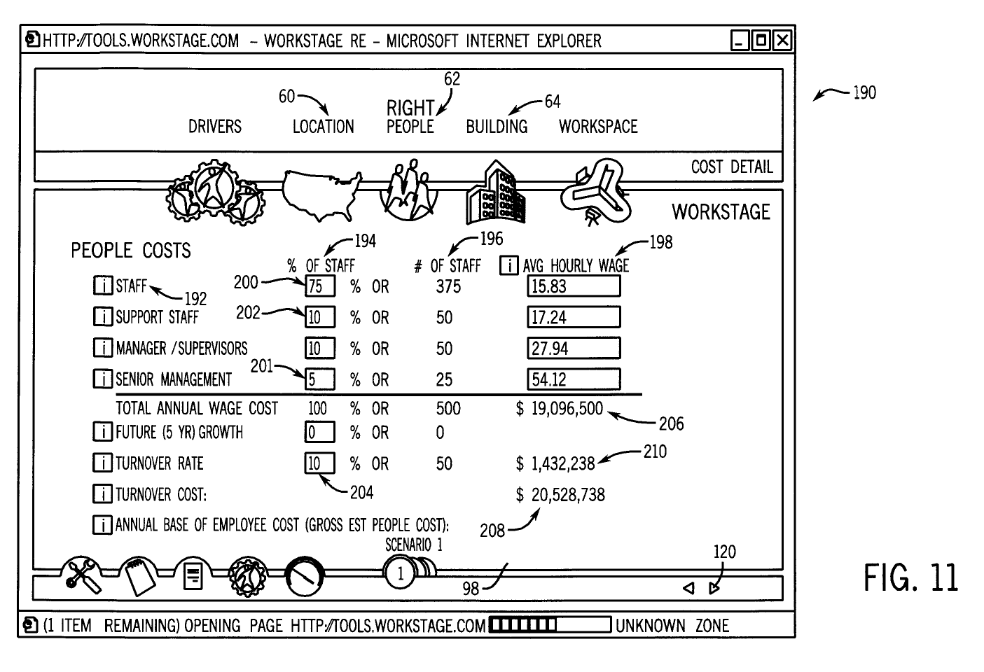

1 After block 648, control passes to block 650 where server 552 accesses the building facility default characteristic database 564 and identifies default building characteristics based on business drivers, building type and default quantities of different employee types. Thus, for instance, referring once again to FIG. 3, where a compelling customer experience is the only mission critical business driver as shown in column 606, all of the building characteristics in column 606 would be specified. Here, consistent with the above example, where there are 25 senior managers, as shown in column 606, 25 private medium-sized senior manager offices would be specified as defaults for the building. Similarly, where the building is to house 50 managers, 50 private small offices would be specified as defaults for the new building as indicated in column 606, and so on. At block 652, location related labor and construction costs are accessed, and at block 654, the default quantities of employee types and location related labor data are used to generate labor estimates that may include estimated wages, turnover rates, turn over costs, etc. At block 656, default building characteristics and location related construction data are used to generate default construction cost estimates. After block 656, all information needed to provide a summary as shown in FIG. 20 has been generated. At block 658, the default building and labor characteristics are presented to the system user. In the illustrated example, default characteristics are provided in the summary form when icon 175 is selected and, if not selected, are provided in a tabular fashion that allows a user to edit the default characteristics as shown in exemplary FIGS. 11 through 19. Here, a first screen shot 190 showing a portion of the default characteristics as in FIG. 11 can be accessed by selecting forward arrow icon 120 or the “People” icon 62 in FIG. 10. 100881 Referring still to FIG. 10, driver icon 177 can be selected to access information in a pop-up window (not illustrated) similar to the information shown in FIG. 7 so that a user can refresh memory regarding how business drivers were bucketed. After refreshing memory, the drivers window can be closed. To edit how business drivers were bucketed, a user can reselect “drivers” icon 58 to go back to screen shot 100 shown in FIG. 7.

Referring yet again to FIG. 10, dashboard icon 179 can be selected at any time after a building location has been specified in fields 172 and 174 to cause a dashboard window like window 482 shown in FIG. 10 to pop up which provides summary information similar to the information in the executive summary shown in FIG. 20., albeit in an abbreviated form. To this end, dashboard window 482 includes a mouse selectable people icon 484, a building icon 486 and a workspace icon 488, along with an abbreviated summary space 490. When the people icon 484 is selected, information related to labor or employees to be associated with the building is provided in space 490 including information corresponding to an annual estimated salary 473, turnover 475 and building costs 477 as shown in FIG. 10. Here, the annual estimated salary is determined by using public wage information for different types of employees and the number of staff, support staff, managers and senior management that it is anticipated will work in a building based on default employee numbers or user specified numbers.

Referring to FIG. 10A, the dashboard window 482 is shown after the building icon 486 has been selected and building related information is provided in space 490. The building related information includes general building specifying information 481 and a speedometer icon 483 that indicates the relationship between a target cost and a cost estimate. Similarly, in FIG. 10B, dashboard window 482 is shown after workspace icon 488 has been selected and workspace related information is provided in area 490. The information subsets in area 490 are only exemplary and other information subsets may be provided in other embodiments.

Referring yet again to FIG. 10, scenario icon 178 is selectable to allow a user to move between any of three different building and location scenarios so that different building and location scenarios can easily be compared to each other. To this end, it has been recognized that system users like to be able to “game” the building and location selection process changing different business driver rankings, facility location and various facility and employee characteristics and to see how those changes effect the ultimate construction, furnishing and labor costs.

In the present embodiment, when a first building and location scenario is specified, second and third scenarios that are identical to the first scenario are automatically specified and can be selected by selection icon 178. Here, as shown in FIG. 10, initially a label “1” is provided in icon 178 indicating a first scenario. To flip to a second scenario, a user clicks on icon 178 once which changes the “1” label to a “2” label. Similarly, to change to the third scenario, the user clicks on icon 178 until a “3” label appears therein. When the user changes from one scenario to another, the user can change the location of a building via fields 172 and 174, can go back to the driver's information by selecting icon 58 and change the bucketing of the business drivers, can change building or facility type by going to the screen shot corresponding to the other scenario as shown in FIG. 8 and so on. In addition, in any of the scenarios, the user can customize the default facility characteristics in a fashion similar to that shown in FIGS. 11 through 19.

This process of automatically creating multiple identical scenarios simultaneously where each scenario can then be customized is particularly advantageous as in most cases, where a real estate maker may want to compare very similar scenarios where only one or a small number of factors are different among the scenarios. For instance, in many cases anticipated number of employees and facility characteristics between two scenarios may be identical, the only difference between the two scenarios being location. Here, instead of requiring a user to specify all scenario characteristics two or three times, a single specification process is required where customization only requires selection of a second location for the second scenario.

Referring still to FIG. 10 and also FIG. 11, once forward arrow icon 120 or “People” 62 is selected, screen shot 190 is provided in the illustrated embodiment. As shown and consistent with the example above, where 500 employees are to use a building and where 75% of the employees will be staffed, 10% of the employees will be support staff, 10% will be managers and 5% will be senior managers, the information provided in space 98 includes an employee type column 192, a percent of staff column 194 and a number of staff column 196 that indicates the percentages and numbers of each of the different types of employees. Thus, for the staff label in column 192, column 194 indicates that 75% of the employees are staff. Column 196 indicates that the number of staff is 375. Similarly, column 194 indicates that 10% of the employees are support staff and column 196 indicates that the number of support staff is 50. Column 198 is an average hourly wage column and includes information obtained via the public human resource database 558 as shown in FIG. 1. Here, the average hourly wages for Fresno, Calif. (see again FIG. 10) are shown for each of a staff employee, a support staff employee, a manager and senior management. Serve 552 automatically determines the total annual wage cost given the number of employees, types of employees and the average hourly wages for the location of the facility selected and provides the total cost at 206. The default turnover rate from database 562 in FIG. 2 is provided at 204 and a turnover cost estimate is provided at 210. An annual base of employee cost including the wage cost and the turnover cost is provided at 208. Here, a user can change the percentages in column 194 or the average hourly wage rates in column 198 and/or the turnover rate at 204 to customize the estimates.

When default values are altered, the changes to the default values can have a rippling affect throughout other defaults and in general can affect the building and labor summary results. To this end, referring again to FIGS. 3 and 11, where the percentage of staff in field 201 corresponding to senior management is changed from 5% to 25% so that there are 125 senior managers instead of 25, an additional 100 senior manager offices have to be constructed which totally affects other building characteristics and the ripple affect occurs.

Referring again to FIG. 11, after forward arrow icon 120 or “Building” icon 64 is selected, screen shot 218 in FIG. 12 is provided. In FIG. 12, the default building is indicated by a dot provided in a binary button spatially associated with an image of the default building shape. In FIG. 12, the dot appears in button 220 associated with the default rectangular shape 222. To change the default shape, a user simply clicks on one of the binary buttons corresponding to one of the other building shapes such as button 224 to select a gull wing building shape as illustrated at 226. After building shape has been selected or accepted, a user selects forward arrow icon 120 and screen shot 250 in FIG. 13 is provided.

As in FIG. 12, images showing building entries are provided along with binary mouse selectable buttons where a default button initially includes a dot as shown at 252. Other entries such as the integrated porch entry shown at 258 can be selected by clicking on the associated buttons (e.g., 256). After an entry has been selected or accepted, a user selects forward arrow icon 120 which causes screen shot 270 in FIG. 14 to be shown.

In FIG. 14, roof types are selectable by selecting binary buttons. Exemplary buttons 272 and 276 correspond to images of buildings having different types of roofs 274 and 278, respectively. After a roof type has been selected or accepted, a user selects forward arrow icon 120 and the system provides screen shot 290 as shown in FIG. 15.

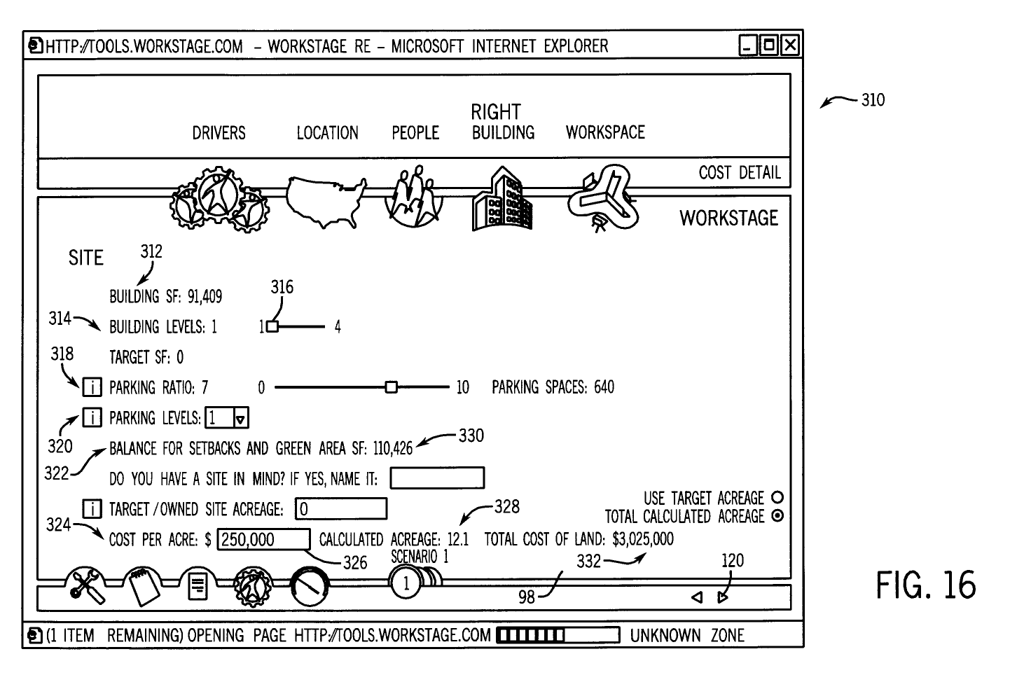

Screen shot 290 allows a user to either view default exterior building skins or to view and edit those default values by changing default percentages. To this end, default exterior skin percentages shown include 45%, 15%, 25% and 15% of concrete, panelized metal, windows and curtain wall, respectively. In addition to the percentages, images showing the different types of skins are provided including a concrete image 294 and a windows image 298. To change the default exterior skin percentages, the user changes the value in a field corresponding to the specific skin type. Exemplary fields include a concrete percentage field 292 and a windows percentage field 236. After skin selections have been made or accepted, a user selects forward arrow icon 120 and screen shot 310 shown in FIG. 16 is provided where additional building default characteristics and some calculated values are shown.

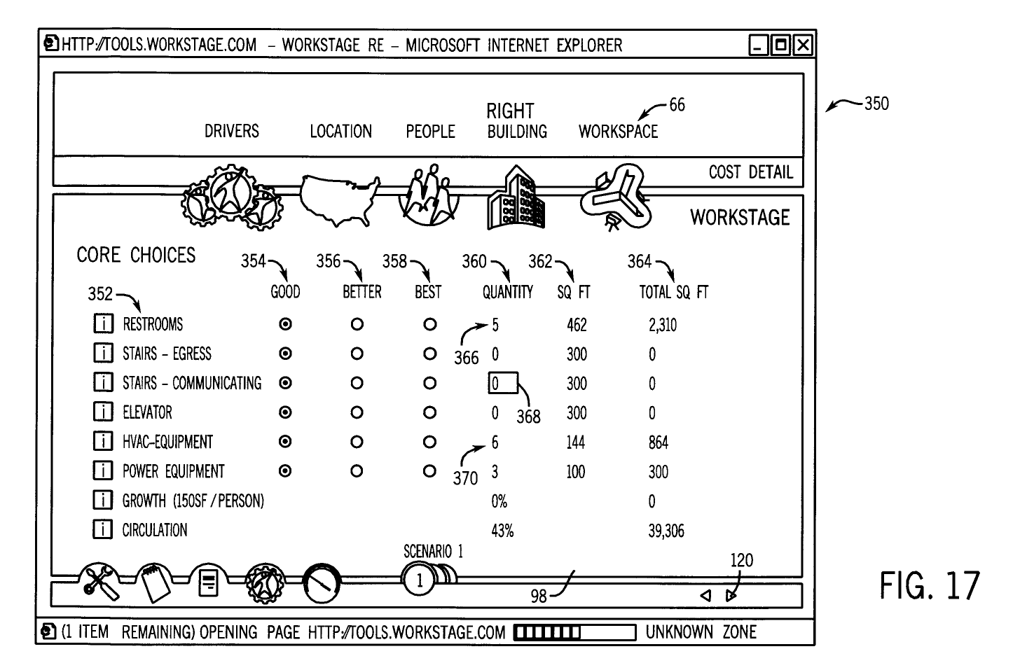

In FIG. 16, one calculated value includes the square feet of an anticipated facility given the previously specified information which is shown at 312. Here, the square feet of the building is determined by adding the square feet of workspaces, conference spaces, circulating spaces, stairwells, restrooms and other spaces required in specific building types. A sliding button 316 is provided for changing the number of levels in the building at 314. A sliding button is provided to adjust the parking ratio at 318. Parking levels can be changed at 320. At 322, a balance for setbacks in green area square feet 330 is provided which, in the present example, cannot be changed because it is typically mandated by local municipalities. An average cost per acre 324 is provided in field 326 which is based on public information. The cost per acre in field 326 can be altered by a user to accommodate special circumstances. Calculated required acreage is provided at 328 and a total cost of land is provided at 332. After a user is done using the tools associated with screen shot 310, forward arrow icon 120 can be selected after which screen shot 350 in FIG. 17 is provided.

In FIG. 17, screen shot 350 includes core building choices in column 352, quality columns including a good column 354, a better column 356, and a best column 358, a quantity column 360, a square foot column 362 and a total square foot column 364. In column 352, core choices for a building include restrooms, stairs, elevators, HVAC equipment, etc. Each of the good, better and best columns 354, 356 and 358 includes a column of binary mouse selectable buttons that can be selected to indicate whether or not one of the choices in column 352 associated therewith should be good, better or best quality. The quantity column 360 includes a number that indicates the quantity of each choice in column 352. For example, column 360 indicates that five restrooms are required (see 366) and that six HVAC system or units are required (see 370). The square foot column specifies square feet for each one of the choices in column 352. The total square foot column 364 includes an entry indicating the total square feet required for the quantity of specific choices specified in columns 360 and 352.

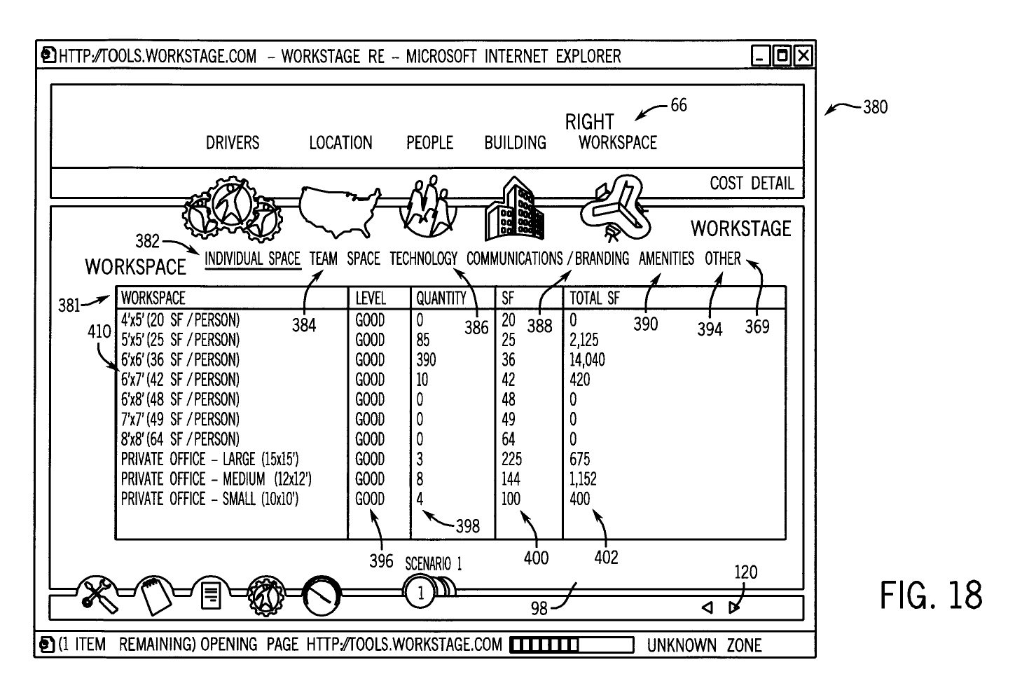

Referring still to FIG. 17, here, it should be appreciated that some of the quantities in column 360 may be altered while others cannot be changed. This is because municipalities routinely require specific numbers of the choices in column 352 and those numbers typically represent more than required resources so that it would be a very rare circumstance where a system user would want to increase the number of specific choices. For instance, five restrooms as indicated at 366 is generally a large number of restrooms given other default building characteristics and, to minimize costs of the building, most users would not opt to increase the number of restrooms. While some quantities in column 360 cannot be changed, other quantities can such as, for instance, the number of communicating stairs in field 368, can be altered. Many other building related screen shots may be provided for examining default building characteristics and customizing those characteristics. After a user is satisfied with the information provided by screen shot 350 and other building characteristic screen shots, the user can select forward icon 120 or “workspace” icon 66 to access screen shot 380 shown in FIG. 18.

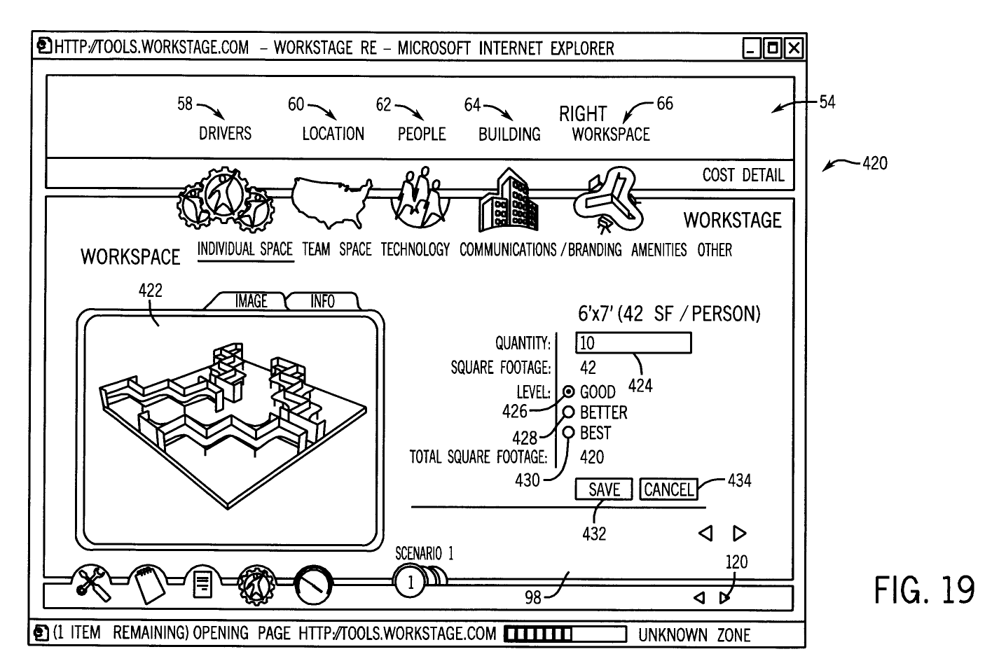

In FIG. 18, screen shot 380 provides default information related to workspaces. Here, an additional toolbar 369 is provided that includes mouse selectable icons labeled “individual space” 382, “team space” 384, “technology” 386, “communication/branding” 388, “amenities” 390 and “other” 394. A user can select any one of icons 382, 384, 386, 388, 390 or 394 to jump to either default or currently specified workspace characteristics and features related to the selected icons. Thus, for instance, individual space icon 382 can be selected to examine current characteristic settings for workspaces as shown in screen shot 380. Screen shot 380 includes a workspace column 381, a level of quality column 396, a quantity column 398, a square foot column 400 and a total square foot column 402. In the illustrated example, it is assumed that a user has already modified the quantities in column 398 so that default values no longer apply. Thus, while the example above associated with FIGS. 2 and 3 requires 25 private small offices, column 398 in FIG. 18 indicates that only four private small offices are required. Other user specified customizations are reflected in screen shot 380. Although not shown, various tools like those described with respect to FIG. 17 will be provided to allow a user to alter default or current individual space settings. In at least some embodiments, information related to any one of the work place types such as the six by seven space at 410 in FIG. 18 may be accessed by simply clicking on the workspace label 410. To this end, referring to FIG. 19, when the label 410 in FIG. 18 is selected, screen shot 420 may be provided to allow a user to see an image 422 of an exemplary default workspace type, to change quantity via a field box 424, to select workspace quality via binary mouse selectable buttons 426, 428 and 430 and to save 432 or cancel 434 modifications.

Although only a few screen shots are shown for viewing and altering default values, it should be appreciated that in complex systems several hundred different screens may be provided for altering and viewing default values.

Referring now to FIG. 20, as indicated above, at any point during the process of examining default or currently set building characteristics or altering default or currently set characteristics, a user can select summary icon 175 causing server 552 to generate a summary page as shown in screen shot 450. The summary page 450 includes five different sections including a short executive summary at 452, location based information at 454, employee information at 456, building information at 458 and workspace information at 460.

After viewing a summary page, a user can select backward arrow icon 119 to move back through the default and customized data. In addition, once a user moves back to a screenshot that includes secondary tool bar 54 (see again FIG. 19), the user can select any one of the bar 54 icons 58, 60, 62, 64, or 66 to access specified information related thereto and to alter that information when necessary. Different summaries 450 can be printed out or saved in a database by selecting print and save icons 461 and 463, respectively (see again FIG. 20).

In at least some embodiments, it is contemplated that programs 557 would allow a user to specify business driver ranking and building/facility characteristics and, as part of the summary screenshot, may provide feedback to the user indicating the specified characteristics that are inconsistent with the driver rankings.

For instance, where first time cost to build and furnish a facility is mission critical and all other drivers are not important, if a system user specifies an extremely complex and expensive building, the summary screenshot 450 may indicate ways to reduce building costs in some fashion to bring the building more into alignment with the way the drivers were ranked.

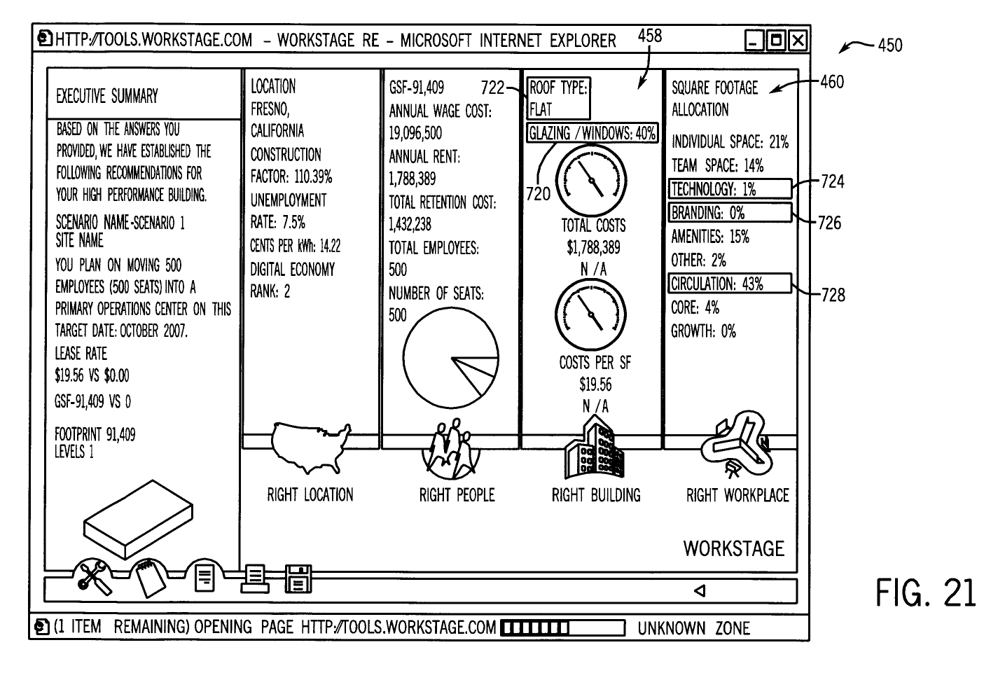

Referring now to FIG. 21, one way to indicate facility characteristics that are not consistent with how drivers were ranked may be to highlight or otherwise visually distinguish various characteristics on the summary page 450. In the illustrated example boxes 722, 720, 724, 726 and 728 are shown around different summary characteristics to signify highlighting. Here, in at least some embodiments, it is contemplated that a user may place a mouse controllable pointing icon over any one of the highlight boxes causing a pop-up window to appear in which suggested changes to the information in the selected box are provided. For instance, where a pointing icon hovers over box 726, a pop-up window could suggest that branding space be increased to 7% of the total space where a compelling customer experience is mission critical. In addition to including suggestions, the pop-up windows could include a “Accept” icon which, when selected, causes the server 552 to replace the information in the box 726 with the suggested value.

Although not illustrated, in other cases suggested facility characteristics that are consistent with business driver ranks could be presented along with the default and customized characteristics on the summary screenshot 450. In some cases suggested characteristics may be able to be toggled on and off via a mouse selectable icon (not illustrated).

In still other cases where a specified facility is inconsistent with the way in which business drivers were bucketed by a user, server 552 may identify different levels of inconsistency and may only specify the most egregious inconsistencies for a user's consideration. For instance, where first cost to build is mission critical and all other drivers are not important but a user specifies a 100% window exterior skin, while other user specified characteristics may be inconsistent with a low first time cost to build, server 552 may be programmed to only suggest that the skin type be changed to a less expensive material.

Referring now to FIG. 5, a subprocess 690 that may be substituted for a portion of the process 640 of FIG. 4 is shown where modifications to user specified facility characteristics are identified and presented to a user to bring a facility more in line with business drivers. Referring also to FIGS. 1 and 4, after block 656, server control may pass to block 692 where a user specifies building preferences and anticipated employee types and quantities. At block 694, server 552 uses the user specified labor and location information to generate labor estimates associated with the user input.

Referring still to FIGS. 1 and 5, at block 698, a summary akin to summary 450 in FIG. 21 is provided that is based on the user specified information. At block 700, server 552 compares presented data and estimates with default data and estimates to identify inconsistencies and at block 702, server 552 indicates inconsistencies and provides suggestions to the user in some fashion.

In addition to the features described above, in at least some embodiments, new real estate and real estate to labor metrics are contemplated that it is believed will be particularly useful to real estate decision makers. To this end, it is known that specific facility designs can result in energy savings to run the facility. For instance, by using a concrete skin as opposed to sheet metal, heating costs may be able to be reduced by 5% for a facility. As another example, by using an open office plan where windows allow natural light to shine into 95% of all individual workspaces, lighting costs may be able to be reduced by 15%.

Similarly, it is generally known that it is far more expensive to reconfigure drywall type office delineating structure than to reconfigure partition wall systems. It is also known that most all facilities are “churned” over time. Here, the term “churn” means inevitable relocating of personnel and equipment and related structural changes to a facility to accommodate the relocation. A typical churn rate may be 20% meaning that 20% of facility space has to be reconfigured on an annual basis. While partition wall type space delineating systems may be more expensive than drywall structures, the cost associated with churn may be substantially less in both materials and labor in the case of a partition wall system.

Here, one interesting real estate related metric is referred to herein as “net effective rent” (NER) which means the triple net lease rate per square foot minus the other costs that would be incurred if a facility had some other baseline type characteristics. For instance, in some cases the cost of churn may be reduced by 0.94 cents per square foot per year and providing additional windows in a facility may reduce lighting cost by 0.38 cents per square foot per year. In this case, if the triple net lease rate is $14.50 per square foot per year, the NER would be $13.18 (i.e., $14.50−0.94−0.38=$13.18).

To facilitate the NER calculation, referring again to FIG. 1, database 555 also includes an NER database 700 that stores data related to benchmark churn and energy savings statistics related to different facility characteristics. Although not shown in detail, it is contemplated that database 700 would include statistics related to percentage of exterior building skin formed by windows and related lighting cost savings, percentage of skin formed by concrete and heating cost savings, average churn cost savings when different building techniques are employed, etc. In addition, to support the NER calculation, in at least some embodiments, a third public database 702 may be accessible by server 552 to access geographically associated energy cost information.

In addition to the NER metric, other potentially interesting metrics include a labor-to-NER ratio (e.g., employees/NER), a seat-to-NER ratio, a turnover-to-NER ratio and an amenity cost/seat ratio. Each of these metrics can be determined by server 552 and provided via display 547.

One other feature that is contemplated is one where benchmark retention costs are tied loosely to facility characteristics so that a real estate decision maker can gain insight into how facility changes can affect labor and overall operating costs. For instance, it is generally known that people like to work in workspaces that are at least in part illuminated via natural light. Thus, it is entirely possible and seems likely that retention rate can be increased by increasing the amount of natural light in a facility. A facility characteristics/retention database is contemplated that will include real life statistical information to show the relationship between natural light in a workspace and retention of employees. For instance, the database may indicate that where natural light in a facility is increased by 20% (e.g., exterior skin includes more windows), retention rates goes up 2%. In other cases the facility characteristics/retention database may not be based on actual statistics and instead may reflect knowledgeable perceptions such as an assumption that an increase in natural light of 20% will increase retention rate by at least 1% where the 1% value is at the low end of an expected range.

In FIG. 1 an exemplary facility characteristics/retention database is shown at 704. It is contemplated that database 704 may include many other benchmark or assumed relationships between building characteristics and retention rates. Similarly, database 555 may include other facility characteristics/results databases (not shown) that relate characteristics to benchmark results or assumptions. For instance, data may be developed for medical facilities that indicates that repeat business can be increased by 15% by increasing the quality of certain facility spaces from good to better and by another 10% by increasing space quality from better to best. [symbol] have realized that patients increasingly select medical facilities as a function of the amenities provided to patients. Thus, where patient rooms in a first hospital are private, include private high end spa type rest rooms and entertainment centers as well as high end decorations (e.g., wall coverings, furniture, artwork, etc.) and in a second hospital rooms are shared, have utilitarian rest rooms and minimal other amenities, patients will routinely prefer the first hospital. In this case the inventive system can he used to show how increases in construction and furnishing costs can directly increase profits.

All of the assumptions made when generating benchmark data can be used to generate other useful information for a system user and to affect the NER metric when appropriate. Thus, while increased construction and furnishing costs will increase a triple net lease cost per square foot, much if not all of the increase in triple net cost will often be offset by reduced turnover; increased work efficiency, increased profitability due to additional and more satisfied clients (e.g., patients), etc.

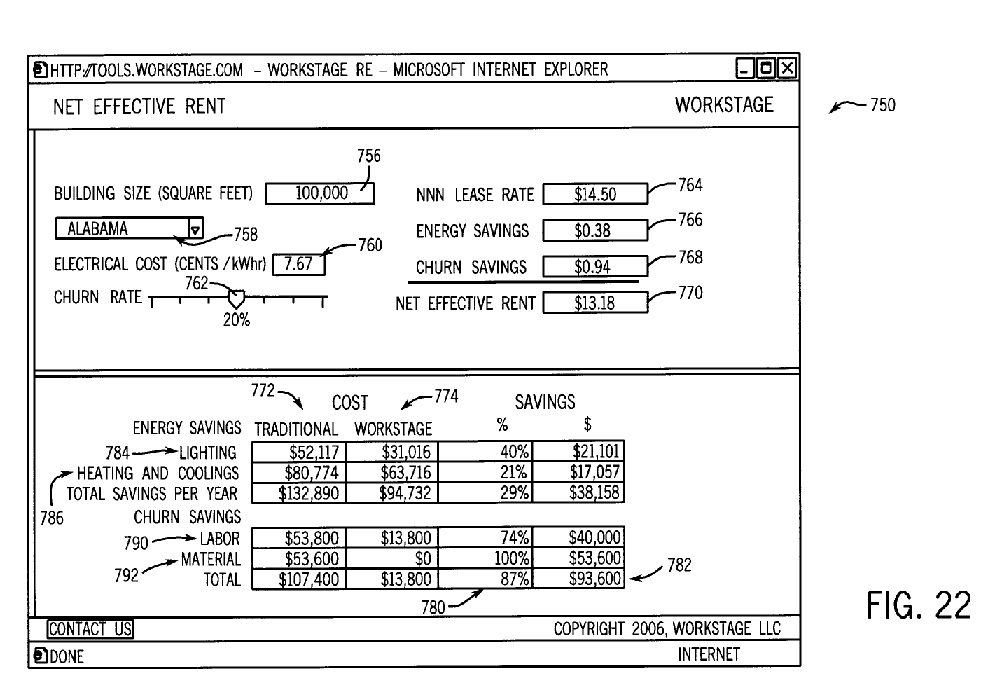

Referring now to FIG. 22, an exemplary screenshot 750 is shown that can be used to see how an exemplary high end facility, when compared to a more traditional type of facility, can affect NER. Screenshot 750 and related tools may be accessible via the pop-up menu (not illustrated) associated with utilities icon 51 (see FIG. 6). In FIG. 22, the high end facility is referred to as a “workstage” facility (see 774). In the illustrated example, it is assumed that facility quality and amenities only affect energy costs and the costs associated with churn. Consistent with the above comments it should be recognized that many other costs and sources of revenue (e.g., turnover rate, work efficiency, client satisfaction, full use of resources, etc.) may also be associated with facility quality and amenities and that those costs and revenue sources could be included in the NER calculation (see NER result at 770).

As shown, exemplary screenshot 750 includes data entry tools and various output fields that report calculated costs and savings associated with the data input via the input tools. The input tools include a building size field 756, a geographical location field 758, a churn rate slider button and a triple net lease rate field 764. A user can specify building size, location, anticipated churn rate and anticipated triple net lease rate via fields and button 756, 758, 762 and 764, respectively. When a location is selected via field 758, server 552 accesses the public energy cost database 702, obtains an energy cost value for the specific location and provides the cost value in an energy cost field 760. Once location specific energy cost has been determined and churn rate has been specified, server 552 generates energy savings and churn savings values per square foot and populates fields 766 and 768, respectively. The values in fields 766 and 768 are subtracted from the triple net rate in field 764 to generate the NER metric in field 770.

Referring still to FIG. 22, comparison data for a traditional facility and the high end facility is provided in a table including a “traditional” column 772, a “workstage” column 774, a “%” savings column 780 and a “cost” savings column 782. In the illustrated example, energy savings is divided into lighting in table row 784 and heating/cooling in row 786 while churn savings is divided into labor and material rows 790 and 792, respectively. As values in fields 756, 758 and 770 and the churn rate specified by button 762 are altered, the resulting numbers output change in real time. Thus, for instance, where the location in field 758 is changed, the energy cost value in field 760 will automatically be changed which ripples through the data in fields 766 and 770 and rows 784 and 786 in the results table. Similarly, if the churn rate is altered via button 762, data in fields 768 and 770 and in rows 790 and 792 is automatically altered.

Referring yet again to FIG. 23, while a user can specify values/information in fields 756, 758, 762 and 764, it should be appreciated that all of that data may simply be imported from default values generated by server 552 in the manner described above. Thus, for instance, a default building size for field 756 will result after a user has ranked business drivers (see FIGS. 6 and 7) and identified building type and numbers of seats and employees (see FIG. 8). Similarly, after a location has been selected (see FIG. 10), the electrical cost for field 760 can be populated.

One or more specific embodiments of the present invention have been described above. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

For instance, while databases 556, 558 and 702 have been described above as being public and in some cases proprietary, in some embodiments the public databases may routinely (e.g., every week) be downloaded into private databases for subsequent use. As another instance, embodiments are contemplated where business drivers are not ranked or even considered by a user and/or where facility types are not considered.

Thus, the invention is to cover all modifications, equivalents, and alternatives falling within the spirit and scope of the invention as defined by the following appended claims. For example,

To apprise the public of the scope of this invention, the following claims are made:

What is claimed is:

1. A site/building decision facilitating apparatus comprising:
a database that correlates building characteristics with business driver factors;
a processor linked to the database and running a program to perform the following acts:
(a) receiving business driver factor information for a first building project via an input device; and
(b) identifying a subset of default building characteristics for the first building project using the database and the received business driver factor information.

2. The apparatus of claim 1 wherein the processor runs the program to further perform the act of rendering the building default characteristics accessible.

3. The apparatus of claim 1 wherein the processor runs the program to further perform the act of receiving personnel information via the input device indicating characteristics of personnel to be associated with the first building project upon completion of the first building project, the act of identifying further including also using the received personnel characteristics to identify the default building characteristics.

4. The apparatus of claim 1 wherein the received business driver factor information includes information corresponding to at least a subset of customer interaction factors, employee interaction factors and employee satisfaction factors.

5. The apparatus of claim 4 wherein the customer factors include at least a subset of a customer service factor, a compelling customer experience factor and a new service/product factor, the employee interaction factors include at least a subset of a communication with employees factor, a productivity effectiveness workflow factor, an innovation fostering factor and a workspace flexibility factor and the employee satisfaction factors include at least a subset of a recruit, retain and train factor, a change in organization factor, a cultural change factor.

6. The apparatus of claim 5 wherein the act of receiving business driver factor information includes receiving information ranking the importance of at least a subset of the business driver factors.

7. The apparatus of claim 1 wherein the processor runs the program to perform the further act of receiving a building cost target for the first building project, the act of identifying a subset of default building characteristics further including using the building cost target to identify the default building characteristics subset.

8. The apparatus of claim 3 wherein the processor runs the program to perform the further acts of receiving building type information via the input device that indicates a general type of building to be constructed pursuant to the first building project and wherein the act of identifying a subset of default characteristics includes also using the building type information to identify the subset.

9. The apparatus of claim 8 wherein the personnel information includes the total number of persons expected to utilize the first building project upon completion and wherein the processor runs the program to further perform the acts of, based on the total number of persons expected to utilize the first building project and the building type, divide the total number of persons expected to utilize the first building type into different employment groupings, the act of identifying a subset of default building characteristics including identifying the default characteristics as a function of the numbers of employees in the different employment groupings.

10. The apparatus of claim 3 wherein the personnel information includes the total number of persons expected to utilize the first building project upon completion.

11. The apparatus of claim 1 wherein the act of identifying a subset of default building characteristics includes identifying at least a subset of total building space required, how the total building space should be divided, how many bathrooms should be included in the first building project, how many conference spaces should be included in the first building project, how many ingresses/egresses should be included in the first building project, the number of offices that should be included in the first building project, the number of partitioned personal spaces that should be included in the first building project, size characteristics of the offices, partitioned spaces, conference rooms and bath rooms to be included in the first building project, locations of the various spaces within the total building space with respect to each other, percentages of external surface of building that will include windows, masonry, panelized metal, concrete and curtain wall for the first building project, roof structure for the first building project, parking features for the first building project, number of floors for the first building project, number and locations of stairwells for the first building project, general shape of the first building project, the acreage required to accommodate the first building project and quality factors related to at least a subset of the spaces suggested for the first building project.

12. The apparatus of claim 2 wherein the processor runs the program to further perform the acts of, after rendering the default characteristics accessible, receiving user input altering at least a subset of the default characteristics and, when at least a first of the default characteristics is altered, automatically altering at least a second default characteristic that is related to the first default characteristic.

13. The apparatus of claim 12 wherein the step of automatically altering at least a second default characteristic included the act of altering a plurality of default characteristics that are related to the first default characteristic.

14. The apparatus of claim 12 wherein the processor runs the program to further perform the acts of, determining when at least one of the altered characteristics is inconsistent with the received business driver factors and providing an indication that an inconsistency occurred.

15. The apparatus of claim 14 wherein the act of indicating that an inconsistency has occurred includes identifying at least a subset of default and altered characteristics and how the subset of default and altered characteristics can be modified to eliminate the inconsistency and indicating how the subset of default and altered characteristics can be modified to eliminate the inconsistency.

16. The apparatus of claim 1 wherein the processor runs the program to further perform the acts of receiving site selection information via the input device that indicates a first possible location for a first building project, after identifying the subset of default building characteristics, generating a building cost estimate for the first building project as a function of the first possible location and the default building characteristics and rendering the building cost estimate accessible.

17. The apparatus of claim 15 wherein the act of generating a cost estimate for the first building project includes obtaining labor cost estimates associated with construction and materials cost estimates associated with the first possible location and using the labor and materials cost estimates and the subset of default building characteristics to determine generate the first building project estimate.

18. The apparatus of claim 3 wherein the processor runs the program to further perform the acts of receiving site selection information via the input device that indicates a first possible location for a first building project, generating a personnel cost estimate as a function of the received personnel information and the first possible location and rendering the personnel cost estimate accessible wherein the personnel cost estimate is related to at least one of recruiting, retaining and training personnel to be associated with the first building project upon completion.

19. The apparatus of claim 18 wherein the act of generating a personnel cost estimate for the first building project includes obtaining employee cost estimates for the personnel to be associated with the first building project upon completion at the first possible location and using the employee cost estimates and the received personnel information to generate the personnel cost estimate.

20. The apparatus of claim 18 wherein the act of generating a cost estimate for the first building project includes obtaining personnel turnover estimates for the personnel to be associated with the first building project upon completion at the first possible location and using the personnel turnover estimates and the received personnel information to generate the personnel cost estimate.

21. The apparatus of claim 18 wherein the processor runs the program to further perform the acts of, after identifying the subset of default building characteristics, generating a building cost estimate for the first building project as a function of the first possible location and the default building characteristics and rendering the building cost estimate accessible.

22. The apparatus of claim 21 wherein the processor runs the program to further perform the acts of mathematically combining the building cost estimate and the personnel cost estimate to generate a building-to-personnel value and rendering the building-to-personnel value accessible.

23. The apparatus of claim 22 wherein the processor runs the program to further perform the acts of examining the building cost estimate and the personnel cost estimate to identify at least one way to reduce an overall yearly cost estimate and rendering the at least one way accessible.

24. The apparatus of claim 22 wherein the building-to-personnel value is at least one of a net effective rent value, a labor to rent ratio, a seat-to-rent ratio, a turnover to net effective rent ratio and an amenity cost per seat value.

25. The apparatus of claim 1 wherein the processor runs the program to further perform the acts of, receiving building characteristic specifying information via the input device and determining when the received building characteristic specifying information is inconsistent with the received business driver factor information.

26. The apparatus of claim 25 wherein the processor runs the program to further perform the acts of indicating that the received building characteristic specifying information is inconsistent with the received business driver factor information.

27. The apparatus of claim 26 wherein the act of indicating the inconsistency includes identifying changes to the received building characteristic specifying information that will cause the characteristic specifying information to be consistent with the received business driver factors and rendering the changes accessible.

28. The apparatus of claim 1 wherein the business driver factors include at least a subset of a productivity effectiveness workflow factor, a compelling customer experience factor, an energy costs of real estate factor, a change in organization factor, an availability end cost of labor factor, a new service/product factor, a capital investment factor, an impact on the environment factor, a communication with employees factor, a customer service factor, a first time cost to build factor, an innovation fostering factor, a recruit, train and retain factor, a downtime factor, a workspace flexibility factor and a cultural change factor.

29. A site/building decision facilitating apparatus comprising:
a processor running a program to perform the following acts:
(a) receiving personnel information indicating characteristics of personnel to be associated with a first building project upon completion of the first building project;
(b) receiving a subset of building characteristics indicating characteristics of the first building project;
(c) receiving site selection information that indicates a first possible location for a first building project;
(d) generating a building cost estimate for the first building project as a function of the first possible location and the received subset of building characteristics; and
(e) generating a personnel cost estimate as a function of the received personnel information and the first possible location.

30. The apparatus of claim 29 wherein the processor runs the program to further perform the act of rendering each of the personnel cost estimate and the building cost estimate accessible.

31. The method of claim 29 wherein the processor runs the program to further perform the act of mathematically combining the building cost estimate and the personnel cost estimate to generate a building-to-personnel value.

32. The method of claim 31 wherein the processor runs the program to further perform the act of rendering the building-to-personnel value accessible.

33. The apparatus of claim 31 wherein the building-to-personnel value is at least one of a net effective rent value, a labor to rent ratio, a seat-to-rent ratio, a turnover to net effective rent ratio and an amenity cost per seat value.

34. The apparatus of claim 29 further including a database that correlates building characteristics with personnel cost information wherein the database is accessible to the processor, the processor running the program to further perform the acts of, after generating the cost estimates, accessing the database to identify changes to the received building characteristics can reduce the personnel cost estimate and rendering the identified changes accessible.

35. The apparatus of claim 29 wherein the act of generating a personnel cost estimate for the first building project includes obtaining employee cost estimates for the personnel to be associated with the first building project upon completion at the first possible location and using the employee cost estimates and the received personnel information to generate the personnel cost estimate.

36. The apparatus of claim 29 wherein the act of generating a cost estimate for the first building project includes obtaining personnel turnover estimates for the personnel to be associated with the first building project upon completion at the first possible location and using the personnel turnover estimates and the received personnel information to generate the personnel cost estimate.

37. A site/building decision facilitating apparatus comprising:
a database that correlates building characteristics with building types;
a processor linked to the database and running a program to perform the following acts:
(a) receiving building type information for a first building project via an input device;
(b) receiving personnel information via the input device indicating characteristics of personnel to be associated with the first building project upon completion of the first building project; and
(c) identifying a subset of default building characteristics for the first building project using the database, the received building type information and the received personnel information.

38. The apparatus of claim 37 wherein the processor runs the program to further perform the act of rendering the building default characteristics accessible.

39. The apparatus of claim 37 wherein the building type information includes at least one of an industry to be associated with the first building project and a specific use to be associated with the first building project.

40. A computer readable medium having stored thereon computer executable instructions for performing the following acts:
analyzing business driver factors, personnel information and location related information to identify at least a subset of default building characteristics associated with a first building project; and
rendering the subset of default building characteristics accessible.

41. A site/building decision facilitating apparatus comprising:
a processor linked to the database and running a program to perform the following acts:
(a) receiving personnel information indicating characteristics of personnel to be associated with a first building project upon completion of the first building project;
(b) receiving site selection information that indicates a first possible location for a first building project;
(c) generating a building cost estimate for the first building project as a function of the first possible location and the received personnel information; and
(d) generating a personnel cost estimate as a function of the received personnel information and the first possible location.

42. A site/building decision facilitating apparatus comprising:
a database that correlates building characteristics with real estate driver factors;
a processor linked to the database and running a program to perform the following acts:
(a) receiving real estate driver factor information for a first building project via an input device;
(b) identifying a subset of default building characteristics for the first building project using the database and the received real estate driver factor information;
(c) monitoring for a summary command;
(d) when a summary command is received, skipping to act (h);
(e) receiving a specified building characteristic;
(f) replacing at least one of the characteristics in the default building characteristics subset with the specified building characteristic;
(g) skipping to act (c); and
(h) providing a summary of the building characteristic subset based on the default and specified characteristics.

43. The apparatus of claim 42 wherein the real estate driver factor information includes at least a subset of the number of persons to be associated with the first building project after completion, the intended use for the first building project, the industry associated with the first building project, business drivers associated with the first building project and a target cost associated with the first building project.

44. A site/building decision facilitating method comprising the acts of:
providing a database that correlates building characteristics with business driver factors;
receiving business driver factor information for a first building project via an input device; and
identifying a subset of default building characteristics for the first building project using the database and the received business driver factor information.

45. A site/building decision facilitating method comprising the acts of:
(a) receiving personnel information indicating characteristics of personnel to be associated with a first building project upon completion of the first building project;
(b) receiving a subset of building characteristics indicating characteristics of the first building project;
(c) receiving site selection information that indicates a first possible location for a first building project;
(d) generating a building cost estimate for the first building project as a function of the first possible location and the received subset of building characteristics; and
(e) generating a personnel cost estimate as a function of the received personnel information and the first possible location.

46. A site/building decision facilitating method comprising the acts of:
(a) providing a database that correlates building characteristics with building types;
(b) receiving building type information for a first building project via an input device;
(c) receiving personnel information via the input device indicating characteristics of personnel to be associated with the first building project upon completion of the first building project; and
(d) identifying a subset of default building characteristics for the first building project using the database, the received building type information and the received personnel information.

47. A site/building decision facilitating method comprising the acts of:
(a) receiving personnel information indicating characteristics of personnel to be associated with a first building project upon completion of the first building project;
(b) receiving site selection information that indicates a first possible location for a first building project;
(c) generating a building cost estimate for the first building project as a function of the first possible location and the received personnel information; and
(d) generating a personnel cost estimate as a function of the received personnel information and the first possible location.
